(19) United States
(12) Patent Application Publication
(10) Pub. No.: US 2023/0097049 A1
(43) Pub. Date: Mar. 30, 2023

(54) Propylene-Based Elastomer Compositions, Articles Thereof, and Methods Thereof

(71) Applicant: ExxonMobil Chemical Patents Inc,, Baytown, TX (US)

(72) Inventors: Rue Xie, Baytown, TX (US); Krishnan Arantha Narays and Iyer, Manvel, TX (US); Shanshan Zhang, Houston, TX (US); Iverel Gerard E. Tumbaga, Spring, TX (US); Ying Ying Sun, Shanghai (CN); Antonios K. Doufas, Houston, TX (US); Peijun Jiang, Katy, TX (US); Jun Shi, Houston, TX (US); Narayanaswami Dharmarajan, Houston, TX (US)

(21) Appl. No.: 17/782,732

(22) PCT Filed: Dec. 11, 2020
(86) PCT No.: PCT/US2020/064645

§ 371 Date: Jun. 6, 2022

Related U.S. Application Data
(60) Provisional application No. 62/947,937, filed on Dec. 13, 2019.

(51) Int. Cl. C08L 23/16

(52) U.S. Cl. CPC C08L 23/16; C08L 2201/02; C08L 2205/03; C08L 2310/00

(57) ABSTRACT

The present disclosure provides compositions comprising propylene-based elastomer, articles thereof, and methods thereof. In at least one embodiment, a composition includes a propylene-based elastomer having an Mw of about 300,000 g/mol to about 600,000 g/mol and a melt flow rate of less than about 3 g/10 min, according to ASTM D-1238 (2.16 kg weight @ 230° C.). The composition includes a thermoplastic resin. In at least one embodiment, a roofing material includes a membrane. The membrane includes a composition. The composition includes a propylene-based elastomer having an Mw of about 300,000 g/mol to about 600,000 g/mol and a melt flow rate of less than about 3 g/10 min, according to ASTM D-1238 (2.16 kg weight @ 230° C.). The roofing material further includes a base material adhered to the membrane or affixed to the membrane.

### CROSS-REFERENCE TO RELATED APPLICATIONS

This application claims priority to U.S. Ser. No. 62/947,937, filed Dec. 13, 2019, herein incorporated by reference.

### FIELD

The present disclosure provides compositions comprising propylene-based elastomer, articles thereof, and methods thereof.

### BACKGROUND

Compositions and membranes comprising thermoplastic olefin (TPO) polymers have found widespread use in the roofing industry for commercial buildings. TPO membranes are often fabricated as a composite structure containing a reflective membrane (40 to 60 mils thick), a reinforcing polyester scrim fabric (1 to 2 mils thick), and a pigmented layer (40 to 60 mils thick). When the membrane is applied to the roof, the reflective membrane layer is exposed to sunlight while the pigmented layer (which is underneath the reflective layer) is attached to the roof insulation material.

For roofing and other sheeting applications, the products are typically manufactured as membrane sheets having a typical width of 10 feet (3 meters) or greater, although smaller widths may be available. The sheets are typically sold, transported, and stored in rolls. For roofing membrane applications, several sheets are unrolled at the installation site, placed adjacent to each other with an overlapping edge to cover the roof and are sealed together by a heat welding process during installation. During transport and storage, the rolls can be exposed to extreme heat conditions, such as from 40° C. to 100° C., which can lead to roll blocking of the rolls during storage in a warehouse. After installation, the membranes can be exposed during service to a wide range of conditions that may deteriorate or destroy the integrity of the membrane. As such, a membrane is desired that can withstand a wide variety of service temperatures, such as from −40° C. to 40° C.

The polymer matrix that is commonly used in TPO roofing membranes is a high rubber content reactor TPO. This resin finds application where a combination of processability and softness is needed. There is market need to fabricate TPO roofing membranes with further enhancement in flexibility compared to compositions containing a conventional resin, as well as an ability to maintain elevated temperature properties. There is also a need for compositions capable of maintaining performance and processability. For processability, melt strength can be important for providing dimensional stability; which would need melt strength comparable to that of compositions containing a commercial resin, such as Hifax™ resin. For example, compositions based on commercial resins might provide sufficient mechanical properties, but improved melt strength for processability is needed.

There is a need for compositions and roofing membranes that demonstrate a balance of elastic modulus (flexibility) at temperatures from −40° C. to 40° C., elastic modulus at elevated temperatures (e.g., 100° C.) (an attribute that mitigates roll blocking), and higher melt strength (that provides improved dimensional stability in a sheeting process).

The present disclosure provides compositions comprising propylene-based elastomer, articles thereof, and methods thereof.

### BRIEF DESCRIPTION OF THE DRAWING

FIG. 1 is a nonlimiting example of a multilayered roofing membrane that, when applied to a roof, is attached to insulation that is attached to a roof.

FIG. 2 is a graph illustrating Elastic modulus, E, versus temperature of compositions, according to an embodiment.

FIG. 3 is a graph illustrating melt strength of compositions, according to an embodiment.

FIG. 4 is a graph of extensional viscosity versus time comparing fractional MFR PBE to control samples, according to an embodiment.

FIG. 5 is a graph of extensional viscosity versus time comparing PBE-VNB to control samples, according to an embodiment.

FIG. 6 is a graph of extensional viscosity versus time comparing branched PBE to non-branched PBE, according to an embodiment of the invention.

FIG. 7 is a Van Gurp-Palmen plot of complex modulus (Pa) versus phase angle (deg) comparing branched PBE to non-branched PBE, according to an embodiment.

FIG. 8A illustrates the GPC data for the resultant polymers (FIG. 8B is a zoomed in plot of FIG. 8A).

FIG. 9 shows a plot of Elastic modulus (E′) with temperature.

FIG. 10 shows the melt strength of selected neat polymers.

FIG. 11 shows the melt strength of selected blends.

FIG. 12 shows the DSC results to compare the thermal behavior of the neat VISTAMAXX™ 3588 and the VISTAMAXX™ 3588-g-PS.

### DETAILED DESCRIPTION

The present disclosure provides compositions comprising propylene-based elastomer, articles thereof, and methods thereof. For example, compositions can include propylene-based elastomers that are suitable for roofing applications, such as membranes. Compositions of the present disclosure can be particularly useful for roofing applications, such as for thermoplastic polyolefin roofing membranes. Compositions and membranes of the present disclosure may exhibit a combination of properties, and in particular exhibit a balance of elastic modulus (flexibility) at temperatures from −40° C. to 40° C., elastic modulus at elevated temperatures (e.g., 100° C.) (an attribute that mitigates roll blocking), and higher melt strength (that provides improved dimensional stability in a sheeting process). The improved melt strength and processability provided by compositions of the present disclosure can provide uniform dispersion of fillers, if present in a composition, which provides more uniform layers (films) for roofing applications, providing improved physical properties of the layers (films).

The improved compositions may include PBE polymers having at least one of the following properties (i) having a low, fractional melt flow rate, (ii) including long chain branching, and (iii) grafted with polystyrene. Advantageously, such PBEs have an increased melt strength and extensional viscosity as compared to conventional PBE. Described herein are formulations comprising such PBEs that are suitable for roofing applications, particularly roofing membranes. Said formulations provide a balance of properties over a wide range of temperatures.

All numerical values within the detailed description and the claims herein are modified by “about” or “approximately” the indicated value, and take into account experimental error and variations that would be expected by a person having ordinary skill in the art.

As used herein, the term “copolymer” is meant to include polymers having two or more monomers, optionally, with other monomers, and may refer to interpolymers, terpolymers, etc. The term “polymer” as used herein includes homopolymers, copolymers, terpolymers, etc., and alloys and blends thereof. The term “polymer” as used herein also includes impact, block, graft, random, and alternating copolymers. The term “polymer” shall further include all possible geometrical configurations unless otherwise specifically stated. Such configurations may include isotactic, syndiotactic and atactic symmetries. The term “blend” as used herein refers to a mixture of two or more polymers. The term “elastomer” shall mean any polymer exhibiting some degree of elasticity, where elasticity is the ability of a material that has been deformed by a force (such as by stretching) to return at least partially to its original dimensions once the force has been removed.

The term “monomer” or “comonomer,” as used herein, can refer to the monomer used to form the polymer, i.e., the unreacted chemical compound in the form prior to polymerization, and can also refer to the monomer after it has been incorporated into the polymer, also referred to herein as a “[monomer]-derived unit”. Different monomers are discussed herein, including propylene monomers, ethylene monomers, and diene monomers.

“Reactor grade,” as used herein, means a polymer that has not been chemically or mechanically treated or blended after polymerization in an effort to alter the polymer's average molecular weight, molecular weight distribution, or viscosity. Particularly excluded from those polymers described as reactor grade are those that have been visbroken or otherwise treated or coated with peroxide or other prodegradants. For the purposes of this disclosure, however, reactor grade polymers include those polymers that are reactor blends.

“Reactor blend,” as used herein, means a highly dispersed and mechanically inseparable blend of two or more polymers produced in situ as the result of sequential or parallel polymerization of one or more monomers with the formation of one polymer in the presence of another, or by solution blending polymers made separately in parallel reactors. Reactor blends may be produced in a single reactor, a series of reactors, or parallel reactors and are reactor grade blends. Reactor blends may be produced by any polymerization method, including batch, semi-continuous, or continuous systems. Particularly excluded from “reactor blend” polymers are blends of two or more polymers in which the polymers are blended ex situ, such as by physically or mechanically blending in a mixer, extruder, or other similar device.

### Compositions

Compositions of the present disclosure include a polymer blend of one or more propylene-based elastomers and one or more thermoplastic resins. In at least one embodiment, a composition has from about 1 wt % to about 60 wt % propylene-based elastomer content, such as from about 5 wt % to about 40 wt %, such as from about 20 wt % to about 40 wt %, such as from about 25 wt % to about 35 wt %, such as about 30 wt %, based on the weight of the composition. In at least one embodiment, a composition has from about 1 wt % to about 60 wt % thermoplastic resin content, such as from about 5 wt % to about 40 wt %, such as from about 20 wt % to about 40 wt %, such as from about 25 wt % to about 35 wt %, such as about 30 wt %, based on the weight of the composition. In an embodiment, the polymer blend includes less than 15 wt % ethylene.

Compositions of the present disclosure may include one or more additives. The additives may include reinforcing and non-reinforcing fillers, antioxidants, stabilizers, processing oils, compatibilizing agents, lubricants (e.g., oleamide), antiblocking agents, antistatic agents, waxes, coupling agents for the fillers and/or pigment, pigments, fire retardants, antioxidants, or other processing aids. In some embodiments, the compositions may include from about 1 wt % to about 60 wt % additive content, such as from about 5 wt % to about 40 wt %, such as from about 20 wt % to about 40 wt %, such as from about 25 wt % to about 35 wt %, such as about 30 wt %, based on the weight of the composition.

Compositions of the present disclosure may have a melt flow rate (MFR) of at least 0.01 dg/min (such as 0.1 to 50 dg/min, such as 0.2 to 30 dg/min, such as 0.1 to 1.5 dg/min, such as 0.15 to 1.4 dg/min, such as 0.0.9 to 1.3 dg/min) (ASTM 1238, 2.16 kg, 230° C.). Alternately, the composition may have a melt flow rate (MFR) of at least 0.01 dg/min (such as 0.1 to 50 dg/min, such as 1 to 10 dg/min).

A composition may have elasticity while in the melt phase. “Tan Delta” is the ratio of viscous modulus (E″) to elastic modulus (E′) and is a useful quantifier of the presence and extent of elasticity in the melt. In some embodiments, the Tan Delta of the composition is greater than 4, or 6, or 8, or 10, or within a range from 4, or 6, or 8, or 10 to 20, or 24, or 28, or 32, or 36.

In at least one embodiment, a composition of the present disclosure can have a viscous modulus (E″) at −40° C. of from about 2.0E+10 to about 7.0E+10, determined according to the method described below.

In at least one embodiment, a composition of the present disclosure can have a viscous modulus (E″) at 100° C. of from about 3.0E+08 to about 3.0E+09, determined according to the method described below.

In at least one embodiment, a composition of the present disclosure can have an elastic modulus (E′) at −40° C. of from about 4.0E+09 to about 7.0E+09, determined according to the method described below.

In at least one embodiment, a composition of the present disclosure can have an elastic modulus (E′) at 100° C. of from about 8.0E+07 to about 2.0E+08, determined according to the method described below.

Films made from compositions of the present disclosure can have a stiffness (1% flexural modulus) in the machine direction (MD) and the transverse direction (TD) of greater than 200 MPa, or greater than 225 MPa, such as about 250 MPa to about 1,000 MPa, such as about 300 MPa to about 500 MPa.

In one or more embodiments, a monolayer containing the polyolefin composition has relatively high values for Stiffness (1% flexural modulus), in each of the MD and the TD, independently. The polyolefin composition has a 1% flexural modulus MD (in the machine direction) of greater than 200 MPa, greater than 225 MPa, greater than 250 MPa, or greater than 275 MPa, such as about 200 MPa, 300 MPa, about 400 MPa, about 500 MPa, or about 600 MPa to about 700 MPa, about 800 MPa, about 900 MPa, about 1,000 MPa, about 1,200 MPa, about 1,500 MPa or greater, as determined if a layer (e.g., monolayer) of the polyolefin composition has a thickness of about 50 μm. For example, the polyolefin composition has a 1% flexural modulus MD of greater than or about 200 MPa to about 1,500 MPa, greater than or about 225 MPa to about 1,500 MPa, greater than or about 250 MPa to about 1,500 MPa, greater than or about 275 MPa to about 1,500 MPa, about 300 MPa to about 1,500 MPa, about 300 MPa to about 1,200 MPa, about 300 MPa to about 1,000 MPa, about 250 MPa to about 1,000 MPa, about 300 MPa to about 800 MPa, about 300 MPa to about 600 MPa, about 300

MPa to about 500 MPa, about 400 MPa to about 1,200 MPa, about 400 MPa to about 1,000 MPa, about 400 MPa to about 800 MPa, or about 400 MPa to about 600 MPa, as determined if a film comprising the polyolefin composition has a thickness of about 50 μm. The 1% flexural modulus is determined by the method provided below.

In one or more embodiments, a monolayer containing the polyolefin composition has a 1% flexural modulus TD (in the traverse direction) of greater than 200 MPa, greater than 225 MPa, greater than 250 MPa, greater than 275 MPa, or greater than 300 MPa, such as from about 320 MPa, about 340 MPa, about 350 MPa, about 400 MPa, about 500 MPa, or about 600 MPa to about 700 MPa, about 800 MPa, about 900 MPa, about 1,000 MPa, about 1,200 MPa, about 1,500 MPa or greater, as determined if a layer (e.g., monolayer) of the polyolefin composition has a thickness of about 50 μm. For example, the polyolefin composition has a 1% flexural modulus TD of about 250 MPa to about 1,500 MPa, about 250 MPa to about 1,200 MPa, about 250 MPa to about 1,000 MPa, about 250 MPa to about 800 MPa, about 250 MPa to about 600 MPa, about 250 MPa to about 500 MPa, about 340 MPa to about 1,500 MPa, about 340 MPa to about 1,200 MPa, about 340 MPa to about 1,000 MPa, about 340 MPa to about 800 MPa, about 340 MPa to about 600 MPa, about 340 MPa to about 500 MPa, about 400 MPa to about 1,200 MPa, about 400 MPa to about 1,000 MPa, about 400 MPa to about 800 MPa, or about 400 MPa to about 600 MPa, as determined if a film comprising the polyolefin composition has a thickness of about 50 μm.

The 1% flexural modulus can be determined by the following: Equipment used: The United Six (6) station, 60 Degree machine contains the following: A load frame testing console containing an electrically driven crosshead mounted to give horizontal movement. Opposite the crosshead are mounted six (6) separate load cells. These load cells are tension load cells.

Units # 1 and # 3 have load cells with a range of 0-35 pounds. Unit # 2 has load cells with a range of 0-110 pounds. Each load cell was equipped with a set of air-actuated jaws. Each jaw has faces designed to form a line grip. The jaw combines one standard flat rubber face and an opposing face from which protrudes a metal half-round. Units # 1 and # 3 have 1 1/4″ wide jaws and Unit # 2 has 2 1/4″ wide jaws.

In one or more embodiments, a monolayer containing the polyolefin composition has a 1% secant modulus MD (machine direction) of greater than 200 MPa, greater than 225 MPa, greater than 250 MPa, or greater than 275 MPa, such as about 200 MPa, 300 MPa, about 400 MPa, about 500 MPa, or about 600 MPa to about 700 MPa, about 800 MPa, about 900 MPa, about 1,000 MPa, about 1,200 MPa, about 1,500 MPa or greater, as determined if a layer (e.g., monolayer) of the polyolefin composition has a thickness of about 50 μm. For example, the polyolefin composition has a 1% secant modulus MD of greater than or about 200 MPa to about 1,500 MPa, greater than or about 225 MPa to about 1,500 MPa, greater than or about 250 MPa to about 1,500 MPa, greater than or about 275 MPa to about 1,500 MPa, about 300 MPa to about 1,500 MPa, about 300 MPa to about 1,200 MPa, about 300 MPa to about 1,000 MPa, about 250 MPa to about 1,000 MPa, about 300 MPa to about 800 MPa, about 300 MPa to about 600 MPa, about 300 MPa to about 500 MPa, about 400 MPa to about 1,200 MPa, about 400 MPa to about 1,000 MPa, about 400 MPa to about 800 MPa, or about 400 MPa to about 600 MPa, as determined if a film comprising the polyolefin composition has a thickness of about 50 μm.

In one or more embodiments, a monolayer containing the polyolefin composition has a 1% secant modulus TD (traverse direction) of greater than 200 MPa, greater than 225 MPa, greater than 250 MPa, greater than 275 MPa, or greater than 300 MPa, such as from about 320 MPa, about 340 MPa, about 350 MPa, about 400 MPa, about 500 MPa, or about 600 MPa to about 700 MPa, about 800 MPa, about 900 MPa, about 1,000 MPa, about 1,200 MPa, about 1,500 MPa or greater, as determined if a layer (e.g., monolayer) of the polyolefin composition has a thickness of about 50 μm. For example, the polyolefin composition has a 1% secant modulus TD of about 250 MPa to about 1,500 MPa, about 250 MPa to about 1,200 MPa, about 250 MPa to about 1,000 MPa, about 250 MPa to about 800 MPa, about 250 MPa to about 600 MPa, about 250 MPa to about 500 MPa, about 340 MPa to about 1,500 MPa, about 340 MPa to about 1,200 MPa, about 340 MPa to about 1,000 MPa, about 340 MPa to about 800 MPa, about 340 MPa to about 600 MPa, about 340 MPa to about 500 MPa, about 400 MPa to about 1,200 MPa, about 400 MPa to about 1,000 MPa, about 400 MPa to about 800 MPa, or about 400 MPa to about 600 MPa, as determined if a film comprising the polyolefin composition has a thickness of about 50 μm. 1% Secant Modulus (M), reported in MPa, can be measured as specified by ASTM D-882-10.

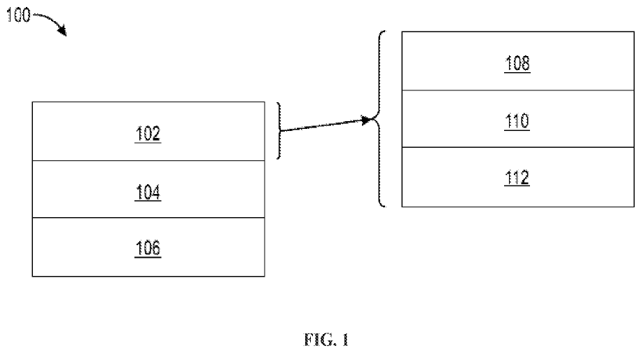

FIG. 1 is a nonlimiting example of a multilayered roofing membrane 102 that, when applied to a roof 106, is attached to insulation 104 that is attached to a roof 106. The illustrated roofing membrane 102 includes three layers: a first TPO membrane 108, a scrim 110, and a second TPO membrane 112. The scrim 110 provides mechanical strength to the multilayered roofing membrane 102. In the illustrated example, the first TPO membrane 108 is outward facing and, preferably, includes an additive to make the first TPO membrane 108 reflective to mitigate heat absorption. Further, the second TPO membrane 112 is at or nearest the insulation 104 and, preferably, includes an additive to make the second TPO membrane 112 dark to improve insulation. In this nonlimiting example, the first TPO membrane 108 and/or the second TPO membrane 112 may be a TPO membrane described herein that comprises a propylene-based polymer, a thermoplastic resin, at least one fire retardant, and at least one ultraviolet stabilizer.

The roofing membranes described herein (single layer or multilayer) may be fixed over the base roofing by any means known in the art such as via adhesive material, ballasted material, spot bonding, or mechanical spot fastening. For example, the membranes may be installed using mechanical fasteners and plates placed along the edge sheet and fastened through the membrane and into the roof decking. Adjoining sheets of the flexible membranes are overlapped, covering the fasteners and plates, and preferably joined together, for example with a hot air weld. The membrane may also be fully adhered or self-adhered to an insulation or deck material using an adhesive. Insulation is typically secured to the deck with mechanical fasteners and the flexible membrane is adhered to the insulation.

The roofing membranes may be reinforced with any type of scrim including, but not limited to, polyester, fiberglass, fiberglass reinforced polyester, polypropylene, woven or non-woven fabrics (e.g., nylon) or combinations thereof. Preferred scrims are fiberglass and/or polyester.

Further, a surface layer of the top and/or bottom of the membrane may be textured with various patterns. Texture increases the surface area of the membrane, reduces glare and makes the membrane surface less slippery. Examples of texture designs include, but are not limited to, a polyhedron with a polygonal base and triangular faces meeting in a common vertex, such as a pyramidal base; a cone configuration having a circular or ellipsoidal configurations; and random pattern configurations.

TPO membranes described herein may have a thickness of about 0.1 mm to about 3 mm (or about 0.1 mm to about 1 mm, or about 0.5 mm to about 2 mm, or about 2 mm to about 3 mm). Multilayer roofing membranes described herein may have a thickness of about 0.5 mm to about 5 mm (or about 0.5 mm to about 2 mm, or about 1 mm to about 3 mm, or about 2 mm to about 5 mm).

### Propylene-Based Elastomers

A composition of the present disclosure includes one or more propylene-based elastomer (“PBE”). The PBE comprises propylene and from about 5 to about 30 wt % of one or more comonomers selected from ethylene and/or C₄-C₁₂ α-olefins, and, optionally, one or more dienes. For example, the comonomer units may be derived from ethylene, butene, pentene, hexene, 4-methyl-1-pentene, octene, or decene. In some embodiments, the comonomer is ethylene. In some embodiments, the propylene-based elastomer composition consists essentially of propylene and ethylene derived units, or consists only of propylene and ethylene derived units. Some of the embodiments described below are discussed with reference to ethylene as the comonomer, but the embodiments are equally applicable to other copolymers with other higher α-olefin comonomers. In this regard, the copolymer may simply be referred to as PBE with reference to ethylene as the α-olefin.

While the molecular weight of the PBE can be influenced by reactor conditions including temperature, monomer concentration and pressure, catalyst system, the presence of chain-terminating or chain-transfer agents and the like, the homopolymer and copolymer products may have an Mw of about 1,000 to about 2,000,000 g/mol, alternately of about 30,000 to about 600,000 g/mol, or alternately of about 100,000 to about 600,000 g/mol, such as about 200,000 g/mol to about 600,000 g/mol, such as about 300,000 g/mol to about 600,000 g/mol, such as about 400,000 g/mol to about 600,000 g/mol, such as about 500,000 g/mol to about 600,000 g/mol, such as about 500,000 g/mol to about 550,000 g/mol, determined by GPC (as described below).

A PBE may have a melt flow rate (MFR) of at least 0.01 dg/min (such as 0.1 to 50 dg/min, such as 0.2 to 30 dg/min, such as 0.1 to 1.5 dg/min, such as 0.15 to 1.0 dg/min, such as 0.15 to 0.8 dg/min, such as 0.15 to 0.5 dg/min) (ASTM 1238, 2.16 kg, 230° C.). Alternately, the PBE may have a melt flow rate (MFR) of at least 0.01 dg/min (such as 0.1 to 50 dg/min, such as 1 to 10 dg/min). Alternately, the PBE may have a melt flow rate (MFR) less than 0.5 dg/min.

A PBE may be a homopolymer or copolymer. In at least one embodiment, the comonomer(s) of a PBE are present at up to 50 mol %, such as from 0.01 to 40 mol %, such as 1 to 30 mol %, such as from 5 to 20 mol %.

In some embodiments, a PBE is a propylene-ethylene copolymer having from 1 to 35 wt % ethylene (such as 5 wt % to 30 wt %, such as 5 wt % to 25 wt %) and 99 wt % to 65 wt % propylene (such as 95 wt % to 70 wt %, such as 95 wt % to 75 wt %), with optionally one or more diene present at up to 10 wt % (such as from 0.00001 wt % to 6.0 wt %, such as from 0.002 wt % to 5.0 wt %, such as from 0.003 wt % to 0.2 wt %), based upon weight of the copolymer. Non-limiting examples of useful dienes include cyclopentadiene, norbornadiene, dicyclopentadiene, 5-ethylidene-2-norbornene (“ENB”), 5-vinyl-2-norbornene, 1,4-hexadiene, 1,5-hexadiene, 1,5-heptadiene, 1,6-heptadiene, 6-methyl-1,6-heptadiene, 1,7-octadiene, 7-methyl-1,7-octadiene, 1,9-decadiene, 1-methyl-1,9-decadiene, and 9-methyl-1,9-decadiene.

In some embodiments herein, a multimodal polyolefin composition is produced, comprising a first polyolefin component and at least another polyolefin component, different from the first polyolefin component by molecular weight, for example such that the GPC trace has more than one peak or inflection point.

The term “multimodal,” when used to describe a polymer or polymer composition, means “multimodal molecular weight distribution,” which is understood to mean that the Gel Permeation Chromatography (GPC) trace, plotted as Absorbance versus Retention Time (seconds), has more than one peak or at least one inflection points. An “inflection point” is that point where the second derivative of the curve changes in sign (e.g., from negative to positive or vice versa). For example, a polyolefin composition that includes a first lower molecular weight polymer component (such as a polymer having an Mw of 100,000 g/mol) and a second higher molecular weight polymer component (such as a polymer having an Mw of 300,000 g/mol) is considered to be a “bimodal” polyolefin composition. For example, the Mw's of the polymer or polymer composition differ by at least 10%, relative to each other, such as by at least 20%, such as at least 50%, such as by at least 100%, such as by a least 200%. Likewise, in at least one embodiment, the Mw's of the polymer or polymer composition differ by 10% to 10,000%, relative to each other, such as by 20% to 1000%, such as 50% to 500%, such as by at least 100% to 400%, such as 200% to 300%.

Unless otherwise indicated, measurements of the moments of molecular weight, i.e., weight average molecular weight (Mw), number average molecular weight (Mn), and z average molecular weight (Mz) are determined by Gel Permeation Chromatography (GPC) as described in Macromolecules, 2001, Vol. 34, No. 19, pg. 6812, which is fully incorporated herein by reference, including that, a High Temperature Size Exclusion Chromatograph (SEC, Waters Alliance 2000), equipped with a differential refractive index detector (DRI) equipped with three Polymer Laboratories PLgel 10 mm Mixed-B columns is used. The instrument is operated with a flow rate of 1.0 cm³/min, and an injection volume of 300 μL. The various transfer lines, columns, and differential refractometer (the DRI detector) are housed in an oven maintained at 145° C. Polymer solutions are prepared by heating 0.75 to 1.5 mg/mL of polymer in filtered 1,2,4-Trichlorobenzene (TCB) containing ^{˜}1000 ppm of butylated hydroxy toluene (BHT) at 160° C. for 2 hours with continuous agitation. A sample of the polymer containing solution is injected into to the GPC and eluted using filtered 1,2,4-trichlorobenzene (TCB) containing ^{˜}1000 ppm of BHT. The separation efficiency of the column set is calibrated using a series of narrow MWD polystyrene standards reflecting the expected Mw range of the sample being analyzed and the exclusion limits of the column set. Seventeen individual polystyrene standards, obtained from Polymer Laboratories (Amherst, Mass.) and ranging from Peak Molecular Weight (Mp)^{˜}580 to 10,000,000, were used to generate the calibration curve. The flow rate is calibrated for each run to give a common peak position for a flow rate marker (taken to be the positive inject peak) before determining the retention volume for each polystyrene standard. The flow marker peak position is used to correct the flow rate when analyzing samples. A calibration curve (log(Mp) vs. retention volume) is generated by recording the retention volume at the peak in the DRI signal for each PS standard, and fitting this data set to a 2nd-order polynomial. The equivalent polyethylene molecular weights are determined by using the Mark-Houwink coefficients shown in Table A.

TABLE A
Mark-Houwink coefficients

| Material | K (dL/g) | α |
|---|---|---|
| PS | 1.75 × 10⁻⁴ | 0.67 |
| PE | 5.79 × 10⁻⁴ | 0.695 |

In at least one embodiment, the homopolymer and copolymer PBE may have a multi-modal, such as bimodal, Mw/Mn.

In some embodiments, the PBE is a tactic polymer, such as an isotactic or highly isotactic polymer. In some embodiments, the PBE is isotactic polypropylene, such as highly isotactic polypropylene.

The term “isotactic polypropylene” (iPP) is defined as having at least 10% or more isotactic pentads. The term “highly isotactic polypropylene” is defined as having 50% or more isotactic pentads. The term “syndiotactic polypropylene” is defined as having 10% or more syndiotactic pentads. The term “random copolymer polypropylene” (RCP), also called propylene random copolymer, is defined to be a copolymer of propylene and 1 to 10 wt % of an olefin chosen from ethylene and C4 to C8 alpha-olefins. For example, isotactic polymers (such as iPP) have at least 20% (such as at least 30%, such as at least 40%) isotactic pentads. A polyolefin is “atactic,” also referred to as “amorphous” if it has less than 10% isotactic pentads and syndiotactic pentads.

Polypropylene microstructure is determined by ¹³C-NMR spectroscopy, including the concentration of isotactic and syndiotactic diads ([m] and [r]), triads ([mm] and [rr]), and pentads ([mmmm] and [rrr]). The designation “m” or “r” describes the stereochemistry of pairs of contiguous propylene groups, “m” referring to meso and “r” to racemic. Samples are dissolved in d2-1,1,2,2-tetrachloroethane, and spectra recorded at 125° C. using a 100 MHz (or higher) NMR spectrometer. Polymer resonance peaks are referenced to mmmm=21.8 ppm. Calculations involved in the characterization of polymers by NMR are described by F. A. Bovey in POLYMER CONFORMATION AND CONFIGURATION (Academic Press, New York 1969) and J. Randall in POLYMER SEQUENCE DETERMINATION, ¹³C-NMR METHOD (Academic Press, New York, 1977).

The PBE may include at least about 5 wt %, at least about 7 wt %, at least about 9 wt %, at least about 10 wt %, at least about 12 wt %, at least about 13 wt %, at least about 14 wt %, at least about 15 wt %, or at least about 16 wt %, α-olefin-derived units, based upon the total weight of the PBE. The PBE may include up to about 30 wt %, up to about 25 wt %, up to about 22 wt %, up to about 20 wt %, up to about 19 wt %, up to about 18 wt %, or up to about 17 wt %, α-olefin-derived units, based upon the total weight of the PBE. In some embodiments, the PBE may comprise from about 5 to about 30 wt %, from about 6 to about 25 wt %, from about 7 wt % to about 20 wt %, from about 10 to about 19 wt %, from about 12 wt % to about 19 wt %, or from about 15 wt % to about 18 wt %, or form about 16 wt % to about 18 wt %, α-olefin-derived units, based upon the total weight of the PBE.

The PBE may include at least about 70 wt %, at least about 75 wt %, at least about 78 wt %, at least about 80 wt %, at least about 81 wt %, at least about 82 wt %, or at least 83 wt %, propylene-derived units, based upon the total weight of the PBE. The PBE may include up to about 95 wt %, up to about 93 wt %, up to about 91 wt %, up to about 90 wt %, up to about 88 wt %, or up to about 87 wt %, or up to about 86 wt %, or up to about 85 wt %, or up to about 84 wt %, propylene-derived units, based upon the total weight of the PBE.

A PBE can be characterized by a melting point (Tm), which can be determined by differential scanning calorimetry (DSC). Using the DSC test method described herein, the melting point is the temperature recorded corresponding to the greatest heat absorption within the range of melting temperature of the sample, when the sample is continuously heated at a programmed rate. When a single melting peak is observed, that peak is deemed to be the “melting point.” When multiple peaks are observed (e.g., principle and secondary peaks), then the melting point is deemed to be the highest of those peaks. It is noted that due to the low-crystallinity of many PBEs, the melting point peak may be at a low temperature and be relatively flat, making it difficult to determine the precise peak location. A “peak” in this context is defined as a change in the general slope of the DSC curve (heat flow versus temperature) from positive to negative, forming a maximum without a shift in the baseline where the DSC curve is plotted so that an endothermic reaction would be shown with a positive peak.

The Tm (first melt) of a PBE (as determined by DSC) may be less than about 120° C., less than about 115° C., less than about 110° C., less than about 105° C., less than about 100° C., less than about 90° C., less than about 80° C., less than about 70° C., less than about 65° C., or less than about 60° C. In some embodiments, the PBE may have a Tm of from about 20° C. to about 110° C., from about 30° C. to about 110° C., from about 40° C. to about 110° C., or from about 50° C. to about 105° C. In some embodiments, the PBE may have a Tm of from about 40° C. to about 70° C., or from about 45° C. to about 65° C., or from about 50° C. to about 60° C. In some embodiments, the PBE may have a Tm of from about 80° C. to about 110° C., or from about 85° C. to about 110° C., or from about 90° C. to about 105° C.

As used herein, DSC procedures for determining Tm is as follows. The polymer is pressed at a temperature of from about 200° C. to about 230° C. in a heated press, and the resulting polymer sheet is annealed, under ambient conditions of about 23.5° C., in the air to cool. About 6 to 10 mg of the polymer sheet is removed with a punch die. This 6 to 10 mg sample is annealed at room temperature (about 23.5° C.) for about 80 to 100 hours. At the end of this period, the sample is placed in a DSC (Perkin Elmer Pyris One Thermal Analysis System) and cooled to about −30° C. to about −50° C. and held for 10 minutes at −50° C. The sample is then heated at 10° C/min to attain a final temperature of about 200° C. The sample is kept at 200° C. for 5 minutes. This is the first melt. Then a second cool-heat cycle (to obtain second melt) is performed, where the sample is cooled to about −30° C. to about −50° C. and held for 10 minutes at −50° C., and then re-heated at 10° C/min to a final temperature of about 200° C. Unless otherwise indicated, Tm referenced herein refers to first melt.

The PBE can be characterized by its percent crystallinity, as determined by X-Ray Diffraction, also known as Wide-Angle X-Ray Scattering (WAXS). The PBE may have a percent crystallinity that is at least about 0.5, at least about 1.0, at least about 1.5. The PBE may be characterized by a percent crystallinity of less than about 2.0, less than about 2.5, or less than about 3.0. For polyethylene and polyethylene copolymers, WAXS can be used to probe the semi-crystalline nature of these materials. Polyethylene forms crystals that are orthorhombic in nature with unit cell dimensions: a=7.41 Å, a=4.94 Å, a=2.55 Å, and α=β=γ=90°. Polyethylene crystalline unit cells then stack together to form crystallites, and plans of these crystals then diffract incident X-rays. The plans of the crystals that diffract X-rays are characterized by their Miller indices (hkl) and for polyethylene, the 3 main diffracting planes, which appear as peaks in the WAXS patterns are (110), (200) and (020). The overall extent of crystallinity for these materials is calculated from the area under each (hkl) values divided by the area of the total WAXS trace. The minimum extent of crystallinity required to observe crystals using WAXS techniques is about 0.5 vol %.

The comonomer content and sequence distribution of the polymers can be measured using ¹³C nuclear magnetic resonance (NMR). Comonomer content of discrete molecular weight ranges can be measured using methods well known to those skilled in the art, including Fourier Transform Infrared Spectroscopy (FTIR) in conjunction with samples by GPC, as described in Wheeler and Willis, Applied Spectroscopy, 1993, Vol. 47, pp. 1128-1130. For a propylene ethylene copolymer containing greater than 75 wt % propylene, the comonomer content (ethylene content) of such a polymer can be measured as follows: A thin homogeneous film is pressed at a temperature of about 150° C. or greater, and mounted on a Perkin Elmer PE 1760 infrared spectrophotometer. A full spectrum of the sample from 600 cm⁻¹ to 4000 cm⁻¹ is recorded and the monomer weight percent of ethylene can be calculated according to the following equation: Ethylene wt %=82.585-111.987X+30.045X², where X is the ratio of the peak height at 1155 cm⁻¹ and peak height at either 722 cm⁻¹ or 732 cm⁻¹, whichever is higher. For propylene ethylene copolymers having 75 wt % or less propylene content, the comonomer (ethylene) content can be measured using the procedure described in Wheeler and Willis. Reference is made to U.S. Pat. No. 6,525,157 which contains more details on GPC measurements, the determination of ethylene content by NMR and the DSC measurements.

A PBE may have a density of from about 0.84 g/cm³ to about 0.92 g/cm³, from about 0.85 g/cm³ to about 0.91 g/cm³, such as from about 0.85 g/cm³ to about 0.87 g/cm³, or from about 0.87 g/cm³ to about 0.9 g/cm³ at room temperature, as measured per the ASTM D-1505 test method, where desirable ranges may include ranges from any lower limit to any upper limit.

A PBE can have a melt index (MI) (ASTM D-1238, 2.16 kg @ 190° C.), of less than or equal to about 10 g/10 min, less than or equal to about 8.0 g/10 min, less than or equal to about 5.0 g/10 min, or less than or equal to about 3.0 g/10 min, or less than or equal to about 2.0 g/10 min. In some embodiments, the PBE may have a MI of from about 0.5 to about 3.0 g/10 min, or from 0.75 to about 2.0 g/10 min, where desirable ranges may include ranges from any lower limit to any upper limit.

A PBE may have a melt flow rate (MFR), as measured according to ASTM D-1238 (2.16 kg weight @ 230° C.), greater than about 0.05 g/10 min, greater than about 0.1 g/10 min, greater than about 0.15 g/10 min, greater than about 0.2 g/10 min, greater than about 0.25 g/10 min, greater than about 0.3 g/10 min, greater than about 0.35 g/10 min, or greater than about 0.4 g/10 min The PBE may have an MFR less than about 10 g/10 min, less than about 4 g/10 min, less than about 3 g/10 min, less than about 2.5 g/10 min, less than about 2 g/10 min, less than about 1.5 g/10 min, less than about 1 g/10 min, or less than about 0.5 g/10 min. In some embodiments, the PBE may have an MFR from about 0.05 to about 10 g/10 min, from about 0.1 to about 3 g/10 min, from about 0.1 to about 2.5 g/10 min, from about 0.15 to about 2 g/10 min, from about 0.2 to about 1 g/10 min, or from about 0.4 to about 0.6 g/10 min, where desirable ranges may include ranges from any lower limit to any upper limit.

The PBE may have a g′ index value of 0.95 or greater, or at least 0.97, or at least 0.99, wherein g′ is measured at the Mw of the polymer using the intrinsic viscosity of isotactic polypropylene as the baseline. For use herein, the g′ index is defined as:

g′=ηb ηl

where ηb is the intrinsic viscosity of the polymer and ηl is the intrinsic viscosity of a linear polymer of the same viscosity-averaged molecular weight (Mv) as the polymer. ηl=KMvα, K and α are measured values for linear polymers and should be obtained on the same instrument as the one used for the g′ index measurement.

Optionally, the PBE may include long chain branching. Branched PBE may have a g′ vis or branching index value less than 1. G′ vis or branching index may be measured using Gel Permeation Chromatography.

Mw, Mn, Mz, number of carbon atoms and g′ᵥᵢₛ are determined by using a High Temperature Size Exclusion Chromatograph (either from Waters Corporation or Polymer Laboratories), equipped with three in-line detectors, a differential refractive index detector (DRI), a light scattering (LS) detector, and a viscometer. Experimental details, including detector calibration, are described in: T. Sun, P. Brant, R. R. Chance, and W. W. Graessley, Macromolecules, Volume 34, Number 19, 6812-6820, (2001) and references therein. Three Polymer Laboratories PLgel 10mm Mixed-B LS columns are used. The nominal flow rate is 0.5 cm³/min, and the nominal injection volume is 300 μL. The various transfer lines, columns and differential refractometer (the DRI detector) are contained in an oven maintained at 145° C. Solvent for the experiment is prepared by dissolving 6 grams of butylated hydroxy toluene as an antioxidant in 4 liters of Aldrich reagent grade 1, 2, 4 trichlorobenzene (TCB). The TCB mixture is then filtered through a 0.7 pm glass pre-filter and subsequently through a 0.1 μm Teflon filter. The TCB is then degas sed with an online degas ser before entering the Size Exclusion Chromatograph. Polymer solutions are prepared by placing dry polymer in a glass container, adding the desired amount of TCB, then heating the mixture at 160° C. with continuous agitation for about 2 hours. All quantities are measured gravimetrically. The TCB densities used to express the polymer concentration in mass/volume units are 1.463 g/ml at room temperature and 1.324 g/ml at 145° C. The injection concentration is from 0.75 to 2.0 mg/ml, with lower concentrations being used for higher molecular weight samples. Prior to running each sample the DRI detector and the injector are purged. Flow rate in the apparatus is then increased to 0.5 ml/minute, and the DRI is allowed to stabilize for 8 to 9 hours before injecting the first sample. The LS laser is turned on 1 to 1.5 hours before running the samples. The concentration, c, at each point in the chromatogram is calculated from the baseline-subtracted DRI signal, I_{DRI}, using the following equation:

c=K_{DRI}I_{DRI}/(dn/dc)

where K_{DRI} is a constant determined by calibrating the DRI, and (dn/dc) is the refractive index increment for the system. The refractive index, n=1.500 for TCB at 145° C. and λ=690 nm. For purposes of this invention and the claims thereto (dn/dc)=0.104 for propylene polymers, 0.098 for butene polymers and 0.1 otherwise. Units on parameters throughout this description of the SEC method are such that concentration is expressed in g/cm³, molecular weight is expressed in g/mole, and intrinsic viscosity is expressed in dL/g.

The LS detector is a Wyatt Technology High Temperature mini-DAWN. The molecular weight, M, at each point in the chromatogram is determined by analyzing the LS output using the Zimm model for static light scattering (M. B. Huglin, LIGHT SCATTERING FROM POLYMER SOLUTIONS, Academic Press, 1971):

$$\frac{{K}_{o} c}{Δ R ( θ )} = \frac{1}{MP ( θ )} + 2 {A}_{2} c$$

Here, ΔR(θ) is the measured excess Rayleigh scattering intensity at scattering angle θ, c is the polymer concentration determined from the DRI analysis, A2 is the second virial coefficient [for purposes of this invention, A₂ =0.0006 for propylene polymers, 0.0015 for butene polymers and 0.001 otherwise], (dn/dc) =0.104 for propylene polymers, 0.098 for butene polymers and 0.1 otherwise, P(θ) is the form factor for a monodisperse random coil, and Kₒ is the optical constant for the system:

$${K}_{o} = \frac{4 {π}^{2} {{n}^{2} ( dn / d c )}^{2}}{{λ}^{4} {N}_{A}}$$

where N_{A} is Avogadro's number, and (dn/dc) is the refractive index increment for the system. The refractive index, n=1.500 for TCB at 145° C. and X=690 nm.

A high temperature Viscotek Corporation viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, is, for the solution flowing through the viscometer is calculated from their outputs. The intrinsic viscosity, [η], at each point in the chromatogram is calculated from the following equation:

η_{S}=c[η]+0.3(c[η])²

where c is concentration and was determined from the DRI output.

The branching index (g′ᵥᵢₛ) is calculated using the output of the SEC-DRI-LS-VIS method as follows. The average intrinsic viscosity, [η]_{avg}, of the sample is calculated by:

$${[ η ]}_{avg} = \frac{\sum {{c}_{i} [ η ]}_{i}}{\sum {c}_{i}}$$

where the summations are over the chromatographic slices, i, between the integration limits. The branching index g′ᵥᵢₛ is defined as:

$${g}^{′} vis = \frac{{[ η ]}_{avg}}{{kM}_{v}^{α}}$$

where, for purpose of this invention and claims thereto, α=0.695 and k =0.000579 for linear ethylene polymers, a =0.705 k=0.000262 for linear propylene polymers, and α=0.695 and k=0.000181 for linear butene polymers. M_{V} is the viscosity-average molecular weight based on molecular weights determined by LS analysis.

In one embodiment, branched PBE may be prepared by a method for long chain branching propylene-based polymers that are prone to peroxide macroradical chain scission via the use radical trapping agents comprising functional nitroxyl groups. Without wishing to be bound by theory, it is believed that the peroxides initiate the grafting of C═C functional groups on to the propylene backbone followed by oligomerization of polymer-bound monomer. Nitroxyl-based radical trapping agents can participate in the H-atom abstraction from the propylene-backbone followed by oligomerization to generate a branched propylene-based polymer. A formulation containing a peroxide and small amounts of radical trapping agent, characterized by at least one nitroxide radical or capable of producing at least one nitroxide radical, while being melt mixed with the propylene-based polymer and at least one unsaturated bond capable of undergoing radical addition reaction can generate significant levels of long chain branching while minimizing the degree of molecular weight reduction.

Such a method may be executed by mixing a PBE with a free radical generator and a coagent via a melt blending process. The process may optionally also include a radical trapping agent. The branched PBE formulations are prepared in a brabender batch mixer of 70 cc capacity at 100 rpm and metal set temperature of 150° C. At time zero a PBE is charged in to the mixer. After about 2-3 minutes of mixing, a radical trapping agent is optionally added, followed by a coagent and a free radical initiator. In some embodiments, the free radical initiator is added prior to the coagent. In another embodiment, the free radical initiator and the coagent are added simultaneously. The compound is then mixed for another 4 minutes.

In an embodiment, from about 95 to 99 wt % of a PBE is mixed with from about 0.3 to 0.6 wt % coagent and from about 0.5 to 1.5 wt % free radical initiator. In embodiments where a radical trapping agent is used, from about 0.5 to 1 wt % radical trapping agent may be added to the mixture.

Suitable radical trapping agents include at least one nitroxide radical and at least one unsaturated bond capable of undergoing radical reaction. Such radical trapping agents include 4-Acryloyloxy-2,2,6,6-tetramethylpiperidine-N-oxyl, (AOTEMPO).

Suitable free-radical initiators may be selected from the group consisting of organic peroxides, organic peresters, and azo compounds. Examples of such compounds include benzoyl peroxide, dichlorobenzoyl peroxide, dicumyl peroxide, di-tert-butyl peroxide, 2,5-dimethyl-2 ,5-di(peroxybenzoate)hexyne-3,1,4-bis (tert-butylperoxyisopropyl)benzene, lauroyl peroxide, tert-butyl peracetate, 2,5-dimethyl-2,5-di(tert-butylperoxy)hexyne-3,2,5-dimethyl-2,5-di(tert-butylperoxy)hexane, tert-butyl perbenzoate, tert-butylperphenyl acetate, tert-butyl perisobutyrate, tert-butyl per-sec-octoate, tert-butyl perpivalate, cumyl perpivalate and tert-butyl perdiethylacetate, azoisobutyronitrile, dimethyl azoisobutyrate. Suitable organic peroxides for crosslinking the polyethylene/NFP blends according to the present invention are available commercially under the trade designation LUPEROX, (preferably 2,5-dimethyl-2,5-di(tert-butylperoxy)hexane, sold by Arkema under the tradename LUPEROX® 101).

Examples of coagents include triallylcyanurate, triallyl isocyanurate, triallyl phosphate, sulfur, N-phenyl bis-maleamide, zinc diacrylate, zinc dimethacrylate, divinyl benzene, 1,2 polybutadiene, trimethylol propane trimethacrylate, tetramethylene glycol diacrylate, trifunctional acrylic ester, dipentaerythritolpentacrylate, polyfunctional acrylate, retarded cyclohexane dimethanol diacrylate ester, polyfunctional methacrylates, acrylate and methacrylate metal salts, oximer for e.g., quinone dioxime.

In another embodiment, branched PBE may be prepared by copolymerization of propylene with limited amounts of one or more comonomers selected from: ethylene, C4-C20 alpha-olefins, and polyenes. For example, propylene, ethylene, and 5-vinyl-2-norbornene (VNB) may be copolymerized to form a PBE-VNB terpolymer. Formation of PBE-VNB polymers is disclosed in U.S. Patent Application No. 2005/0107534.

The PBE may have a Shore D hardness (ASTM D2240) of less than about less than about 50, less than about 45, less than about 40, less than about 35, or less than about 20.

The PBE may have a Shore A hardness (ASTM D2240) of less than about 100, less than about 95, less than about 90, less than about 85, less than about 80, less than about 75, or less than 70. In some embodiments, the PBE may have a Shore A hardness of from about 10 to about 100, from about 15 to about 90, from about 20 to about 80, or from about 30 to about 70, where desirable ranges may include ranges from any lower limit to any upper limit.

In some embodiments, the PBE is a propylene-ethylene copolymer that has at least four, or at least five, or at least six, or at least seven, or at least eight, or all nine of the following properties (i) from about 9 to about 25 wt %, or from about 12 to about 20 wt % ethylene-derived units, based on the weight of the PBE; (ii) a Tm of from 80 to about 110° C., or from about 85 to about 110° C., or from about 90 to about 105° C.; (iii) a Hf of less than about 75 J/g, or less than 50 J/g, or less than 30 J/g, or from about 1.0 to about 15 J/g or from about 3.0 to about 10 J/g; (iv) a MI of from about 0.5 to about 3.0 g/10 min or from about 0.75 to about 2.0 g/10 min; (v) a MFR of from about 0.05 to about 10 g/10 min, or from 0.1 to about 3 g/10 min, or from about 0.1 to about 2.5 g/10 min; (vi) a Mw of from about 500,000 to about 600,000 g/mol, or from about 500,000 to about 550,000 g/mol, alternatively from about 510,000 to about 600,000 g/mol, or from about 525,000 to about 550,000 g/mol; (vii) a Mn of from about 50,000 to about 500,000 g/mol, or from about 150,000 to about 350,000 g/mol, or from about 200,000 to about 250,000 g/mol; (viii) a MWD of from about 1.0 to about 5, or from about 1.5 to about 4, or from about 1.8 to about 3; and/or (ix) a Shore D hardness of less than 30, or less than 25, or less than 20.

Optionally, the PBE may be grafted (i.e., “functionalized”) using one or more grafting monomers. As used herein, the term “grafting” denotes covalent bonding of the grafting monomer to a polymer chain of the propylene-based polymer. The grafting monomer can be or include at least one ethylenically unsaturated carboxylic acid or acid derivative, such as an acid anhydride, ester, salt, amide, imide, acrylates or the like. Illustrative grafting monomers include, but are not limited to, acrylic acid, methacrylic acid, maleic acid, fumaric acid, itaconic acid, citraconic acid, mesaconic acid, maleic anhydride, 4-methyl cyclohexene-1,2-dicarboxylic acid anhydride, bicyclo(2.2.2)octene-2,3-dicarboxylic acid anhydride, 1,2,3,4 ,5,8,9 ,10-octahydronaphthalene-2,3 -dic arboxylic acid anhydride, 2-oxa-1,3-diketospiro(4.4)nonene, bicyclo(2.2.1)heptene-2,3-dicarboxylic acid anhydride, maleopimaric acid, tetrahydrophthalic anhydride, norbornene-2,3-dicarboxylic acid anhydride, nadic anhydride, methyl nadic anhydride, himic anhydride, methyl himic anhydride, and 5-methylbicyclo(2.2.1)heptene-2,3-dicarboxylic acid anhydride. Other suitable grafting monomers include methyl acrylate and higher alkyl acrylates, methyl methacrylate and higher alkyl methacrylates, acrylic acid, methacrylic acid, hydroxy-methyl methacrylate, hydroxyl-ethyl methacrylate and higher hydroxy-alkyl methacrylates and glycidyl methacrylate. Maleic anhydride is an example grafting monomer. In embodiments wherein the graft monomer is maleic anhydride, the maleic anhydride concentration in the grafted polymer can be from about 1 wt % to about 6 wt %, at least about 0.5 wt %, or at least about 1.5 wt %.

Other suitable grafting monomers include polystyrene. The PBE-g-PS described herein may be prepared by in-situ reactive extrusion (e.g., polymerization of styrene monomers and grafting reaction to PBE macromolecular chains carried out in a twin screw extruder). The polystyrene chain is grafted on the PBE (e.g., VISTAMAXX™) main chain. The schematic diagram of grafting reaction and polymerization of styrene monomers during the reactive process is shown below:

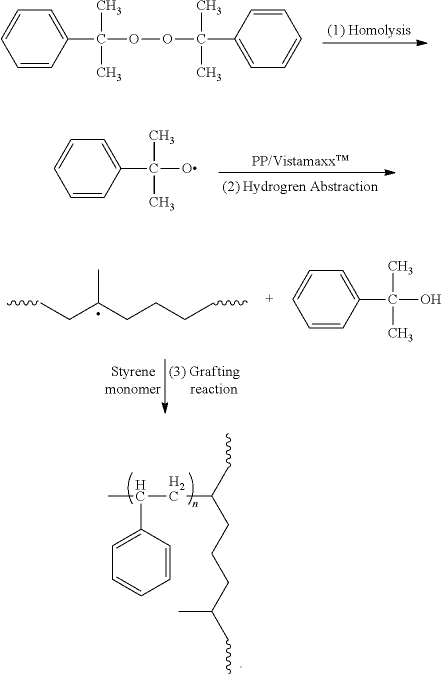

Generally, the in-situ reactive extrusion is carried out by heating and extruding a mixture of propylene-based elastomer (e.g., VISTAMAXX™), styrene monomer, and an initiator (e.g., dicumyl peroxide (DCP)). To improve the distribution of the styrene monomer throughout the propylene-based polymer, the propylene-based elastomer (typically in pellet or flake form) is soaked in a mixture comprising the styrene monomer and initiator. The soaking can be for about 1 hour to about 24 hours or longer (or about 1 hour to about 12 hours, or about 6 hours to about 18 hours, or about 8 hours to about 24 hours) at a temperature below which the polymerization of the styrene would occur (preferably less than about 50° C., or room temperature to about 50° C.).

The amount of styrene monomer in the in-situ reactive extrusion should be determined based on the amount of styrene desired in the final PBE-g-PS product. The amount of initiator is preferably in excess of the amount needed to polymerize the amount of styrene needed, but preferably not in so much excess that significant amounts of initiator remain in the PBE-g-PS product.

The in-situ reactive extrusion can be carried out at temperatures of about 150° C. to about 250° C. (or about 150° C. to about 200° C., or about 150° C. to about 180° C.).

The propylene-based polymer used in producing the PBE-g-PS is preferably a propylene-based elastomer having 70 wt % to 95 wt % of propylene-derived units and 5 wt % to 30 wt % of C2-C6 α-olefin(not propylene)-derived units, and a melting temperature of less than about 120° C. and a heat of fusion of less than about 75 J/g. The C2-C6 alpha-olefin (not propylene) is preferably at least one of ethylene, isobutylene, 1-butene, 1-pentene, 3-methyl-1-pentene, 4-methyl-1-pentene, 1-hexene. More preferably, the C2-C6 alpha-olefin is ethylene.

For example, the propylene-based polymer used in producing the PBE-g-PS may be VISTAMAXX™ 3588 polymer (8 g/10 min MRF, 4 wt % C2) or VISTAMAXX™ 6102 polymer (3 g/10 min MRF, 16 wt % C2) (both propylene-based copolymers, available from ExxonMobil Chemical Company).

At 180° C., a PBE-g-PS described herein may have an extensional viscosity ranging from more than 100 Pa·s to less than 8×10⁴ Pa·s. For example, when using a VISTAMAXX^{Tm} for the PBE, the VISTAMAXX-g-PS may have an extensional viscosity ranging from more than 300 Pa·s to less than 5×10⁵ Pa·s.

The propylene-based polymer used in producing the PBE-g-PS may have an MFR (230° C., 2.16 kg) of about 0.1 g/10 min to about 100 g/10 min (or about 1 g/10 min to about 50 g/10 min, or about 2 g/10 min to about 30 g/10 min, or about 3 g/10 min to about 20 g/10 min).

The polystyrene content of the PBE-g-PS may be about 1 wt % to about 50 wt % (or about 1 wt % to about 20 wt %, or about 5 wt % to about 25 wt %, or about 10 wt % to about 30 wt %, or about 20 wt % to about 40 wt %) based on the total weight of the grafted polymer.

The PBE-g-PS may have an Mw of about 100,000 g/mol to about 500,000 g/mol (or about 100,000 g/mol to about 250,000 g/mol, or about 150,000 g/mol to about 350,000 g/mol, or about 250,000 g/mol to about 500,000 g/mol).

The PBE-g-PS may have an Mn of about 5,000 g/mol to about 50,000 g/mol (or about 5,000 g/mol to about 25,000 g/mol, or about 15,000 g/mol to about 30,000 g/mol, or about 25,000 g/mol to about 50,000 g/mol).

The PBE-g-PS may have an MWD of about 3 to about 20 (or about 3 g/mol to about 10 g/mol, or about 5 g/mol to about 18 g/mol, or about 10 g/mol to about 30 g/mol).

The PBE-g-PS may have a density of about 0.85 g/cm³ to about 1.0 g/cm³ (or about 0.86 g/cm³ to about 0.95 g/cm³, or about 0.88 g/cm³ to about 0.90g/cm³) at room temperature.

In some embodiments, the PBE is a reactor grade or reactor blended polymer, as defined above. That is, in some embodiments, the PBE is a reactor blend of a first polymer component and a second polymer component. Thus, the comonomer content of the PBE can be adjusted by adjusting the comonomer content of the first polymer component, adjusting the comonomer content of the second polymer component, and/or adjusting the ratio of the first polymer component to the second polymer component present in the PBE.

In embodiments where the PBE is a blended polymer, the a-olefin content of the first polymer component (“R1”) may be greater than 5 wt %, greater than 7 wt %, greater than 10 wt %, greater than 12 wt %, greater than 15 wt %, or greater than 17 wt %, based upon the total weight of the first polymer component. The a-olefin content of the first polymer component may be less than 30 wt %, less than 27 wt %, less than 25 wt %, less than 22 wt %, less than 20 wt %, or less than 19 wt %, based upon the total weight of the first polymer component. In some embodiments, the a-olefin content of the first polymer component may range from 5 wt % to 30 wt %, from 7 wt % to 27 wt %, from 10 wt % to 25 wt %, from 12 wt % to 22 wt %, from 15 wt % to 20 wt %, or from 17 wt % to 19 wt %. For example, the first polymer component comprises propylene and ethylene derived units, or consists essentially of propylene and ethylene derived units.

In embodiments where the PBE is a blended polymer, the a-olefin content of the second polymer component (“R2”) may be greater than 1.0 wt %, greater than 1.5 wt %, greater than 2.0 wt %, greater than 2.5 wt %, greater than 2.75 wt %, or greater than 3.0 wt % a-olefin, based upon the total weight of the second polymer component. The a-olefin content of the second polymer component may be less than 10 wt %, less than 9 wt %, less than 8 wt %, less than 7 wt %, less than 6 wt %, or less than 5 wt %, based upon the total weight of the second polymer component. In some embodiments, the a-olefin content of the second polymer component may range from 1.0 wt % to 10 wt %, or from 1.5 wt % to 9 wt %, or from 2.0 wt % to 8 wt %, or from 2.5 wt % to 7 wt %, or from 2.75 wt % to 6 wt %, or from 3 wt % to 5 wt %. For example, the second polymer component can have propylene and ethylene derived units, or consists essentially of propylene and ethylene derived units.

In embodiments where the PBE is a blended polymer, the PBE may comprise from 1 to 25 wt % of the second polymer component, from 3 to 20 wt % of the second polymer component, from 5 to 18 wt % of the second polymer component, from 7 to 15 wt % of the second polymer component, or from 8 to 12 wt % of the second polymer component, based on the weight of the PBE, where desirable ranges may include ranges from any lower limit to any upper limit. The PBE may comprise from 75 to 99 wt % of the first polymer component, from 80 to 97 wt % of the first polymer component, from 85 to 93 wt % of the first polymer component, or from 82 to 92 wt % of the first polymer component, based on the weight of the PBE, where desirable ranges may include ranges from any lower limit to any upper limit.

The PBE may be prepared using homogeneous conditions, such as a continuous solution polymerization process. Exemplary methods for the preparation of PBEs may be found in U.S. Pat. Application No. 2019/0177449, incorporated herein by reference.

For example, the PBE is quinolinyldiamo catalyst catalyzed. Exemplary methods for the preparation of PBEs using a quinolinyldiamo catalyst may be found in U.S. Patent Application No. 2018/0002352, incorporated herein by reference. In at least one embodiment, the PBE is prepared using a quinolinyldiamo catalyst represented by formula (I) or formula (II):

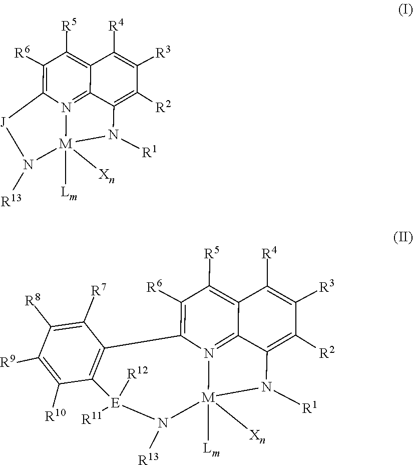

wherein:
M is a Group 3, 4, 5, 6, 7, 8, 9, 10, 11, or 12 metal;
J is a three-atom-length bridge between the quinoline and the amido nitrogen;

E is selected from carbon, silicon, or germanium;
X is an anionic leaving group;
L is a neutral Lewis base;
R¹ and R¹³ are independently selected from the group consisting of hydrocarbyl, substituted hydrocarbyl, and silyl group;
R² through R¹² are independently selected from the group consisting of hydrogen, hydrocarbyl, alkoxy, silyl, amino, aryloxy, substituted hydrocarbyl, halogen, and phosphino;
n is 1 or 2;
m is 0, 1, or 2;
n+m is not greater than 4; and
any two adjacent R groups (e.g., R¹ & R², R² & R³, etc.) may be joined to form a substituted or unsubstituted hydrocarbyl or heterocyclic ring, where the ring has 5, 6, 7, or 8 ring atoms and where substitutions on the ring can join to form additional rings;
any two X groups may be joined together to form a dianionic group;
any two L groups may be joined together to form a bidentate Lewis base; and
an X group may be joined to an L group to form a monoanionic bidentate group.

Non-limiting examples of quinolinyl diamido catalysts that are chelated transition metal complexes include:
N-(2,6-Diisopropylphenyl)-2-{2-[(o-tolylamino)methyl]naphthalen-1-yl}quinolin-8-amino (Hf(Me)₂);
N-(2,6-Diisopropylphenyl)-2-{2-[(2,6-dimethylphenylamino)methyl]naphthalen-1-yl}quinolin-8-amino (Hf(Me)₂);
N-(2,6-Diisopropylphenyl)-2-[3-(phenylamino)-2,3-dihydro-1H-inden-4-yl]quinolin-8-amino (Hf(Me)₂);
N-(2,6-Diisopropylphenyl)-2-[3 -(o-tolylamino)-2,3 -dihydro-1H-inden-4-yl]quinolin-8-amino (Hf(Me)₂);
2-(8-Anilino-5,6,7,8-tetrahydronaphthalen-1-yl)-N-(2,6-diisopropylphenyl)quinolin-8-amino (Hf(Me)₂);
N-(2,6-Diisopropylphenyl)-2-{2-[(o-tolylamino)methyl]naphthalen-1-yl}quinolin-8-amino (Hf(Cl)₂);
N-(2,6-Diisopropylphenyl)-2-{2-[(2,6-dimethylphenylamino)methyl]naphthalen-1-yl}quinolin-8-amino (Hf(Cl)₂);
N-(2,6-Diisopropylphenyl)-2-[3-(phenylamino)-2,3-dihydro-1H-inden-4-yl]quinolin-8-amino (Hf(Cl)₂);
N-(2,6-Diisopropylphenyl)-2-[3 -(o-tolylamino)-2,3 -dihydro-1H-inden-4-yl]quinolin-8-amino (Hf(Cl)₂);
2-(8-Anilino-5,6,7,8-tetrahydronaphthalen-1-yl)-N-(2,6-diisopropylphenyl)quinolin-8-amino (Hf(Cl)₂);
N-(2,6-Diisopropylphenyl)-2-{2-[(o-tolylamino)methyl]naphthalen-1-yl}quinolin-8-amino (Zr(Me)₂);
N-(2,6-Diisopropylphenyl)-2-{2-[(2,6-dimethylphenylamino)methyl]naphthalen-1-yl}quinolin-8-amino (Zr(Me)₂);
N-(2,6-Diisopropylphenyl)-2-[3-(phenylamino)-2,3-dihydro-1H-inden-4-yl]quinolin-8-amino (Zr(Me)₂);
N-(2,6-Diisopropylphenyl)-2-[3 -(o-tolylamino)-2,3 -dihydro-1H-inden-4-yl]quinolin-8-amino (Zr(Me)₂);
2-(8-Anilino-5,6,7,8-tetrahydronaphthalen-1-yl)-N-(2,6-diisopropylphenyl)quinolin-8-amino (Zr(Me)₂);
N-(2,6-Diisopropylphenyl)-2-{2-[(o-tolylamino)methyl]naphthalen-1-yl}quinolin-8-amino (Zr(Cl)₂);
N-(2,6-Diisopropylphenyl)-2-{2-[(2,6-dimethylphenylamino)methyl]naphthalen-1-yl}quinolin-8-amino (Zr(Cl)₂);
N-(2,6-Diisopropylphenyl)-2-[3 -(phenylamino)-2 ,3-dihydro-1H-inden-4-yl]quinolin-8-amino (Zr(Cl)₂);
N-(2,6-Diisopropylphenyl)-2-[3 -(o-tolylamino)-2,3 -dihydro-1H-inden-4-yl]quinolin-8-amino (Zr(Cl)₂);
2-(8-Anilino-5,6,7,8-tetrahydronaphthalen-1-yl)-N-(2,6-diisopropylphenyl)quinolin-8-amino (Zr(Cl)₂); or
mixture(s) thereof.

In another example, the PBE is prepared using a catalyst comprising a group 4 bis(phenolate) complex. Exemplary methods for the preparation of PBEs using a catalyst comprising a group 4 bis(phenolate) complex may be found in PCT Patent Application No. PCT/US2020/045819, incorporated herein by reference. In at least one embodiment, the PBE is prepared using a catalyst comprising a group 4 bis(phenolate) complex represented by formula (III):

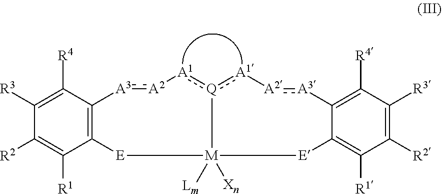

wherein:
M is a group 3-6 transition metal or Lanthanide;
E and E′ are each independently O, S, or NR⁹, where R⁹ is independently hydrogen,
C₁-C₄₀ hydrocarbyl, C₁-C₄₀ substituted hydrocarbyl, or a heteroatom-containing group;
Q is group 14, 15, or 16 atom that forms a dative bond to metal M;
A¹QA^{1′} are part of a heterocyclic Lewis base containing 4 to 40 non-hydrogen atoms that links A² to A^{2′} via a 3-atom bridge with Q being the central atom of the 3-atom bridge,
A¹ and A^{1′} are independently C, N, or C(R²²), where R²² is selected from hydrogen, C₁-C₂₀ hydrocarbyl, C₁-C₂₀ substituted hydrocarbyl;
[symbol] is a divalent group containing 2 to 40 non-hydrogen atoms that links A¹ to the E-bonded aryl group via a 2-atom bridge;
[symbol] is a divalent group containing 2 to 40 non-hydrogen atoms that links A^{1′} to the E-bonded aryl group via a 2-atom bridge;
L is a neutral Lewis base;
X is an anionic ligand;
n is 1, 2 or 3;
m is 0, 1, or 2;
n+m is not greater than 4;
each of R¹, R², R³, R⁴, R^{1′}, R^{2′}, R^{3′}, and R^{4′} is independently hydrogen, C₁-C₄₀ hydrocarbyl, C₁-C₄₀ substituted hydrocarbyl, a heteroatom or a heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings;
any two L groups may be joined together to form a bidentate Lewis base; an X group may be joined to an L group to form a monoanionic bidentate group;
any two X groups may be joined together to form a dianionic ligand group.

### Thermoplastic Resins

The compositions described herein may include one or more thermoplastic resins. The “thermoplastic resin” may be any material that is not a “propylene-based elastomer” as described herein. For example, the thermoplastic resin may be a polymer or polymer blend considered by persons skilled in the art as being thermoplastic in nature, e.g., a polymer that softens when exposed to heat and returns to its original condition when cooled to room temperature. The thermoplastic resin component may be an olefinic thermoplastic resin (contains one or more polyolefins), including polyolefin homopolymers and polyolefin copolymers. Except as stated otherwise, the term “copolymer” means a polymer derived from two or more monomers (including terpolymers, tetrapolymers, etc.) and the term “polymer” refers to any carbon-containing compound having repeat units from one or more different monomers. Thermoplastic resins can be synthesized as described in U.S. Publication Nos. 2019/0177449 A1, U.S. 2018/0002352 A1, and U.S. 2018/0134827, each incorporated herein by reference.

Illustrative polyolefins may be prepared from mono-olefin monomers including, but are not limited to, monomers having 2 to 7 carbon atoms, such as ethylene, propylene, 1-butene, is obutylene, 1-pentene, 1-hexene, 1 -octene, 3 -methyl-1-pentene, 4-methyl-1-pentene, 5-methyl-1-hexene, mixtures thereof, and copolymers thereof. In at least one embodiment, the olefinic thermoplastic resin is unvulcanized or non cross-linked.

Ethylene-based polymers that may be useful include those comprising ethylene-derived units, one or more olefins selected from C₃-C₂₀ olefins (preferably 1-butene, 1-hexene, and/or 1-octene), and optionally one or more diene-derived units. The ethylene-based copolymer may have an ethylene content of greater than or equal to about 70 wt % (or about 70 wt % to about 100 wt %, or about 75 wt % to about 95 wt %, or from about 80 wt % to about 90 wt %) based on the weight of the ethylene-based copolymer, with the balance, if not 100% ethylene, being comonomer-derived units. The ethylene-based polymer may comprise diene-derived units, when present, at about 0.05 wt % to about 6 wt % (or from about 0.05 wt % to about 2 wt %, or about 1 wt % to about 5 wt %, or about 2 wt % to about 6 wt %).

Useful ethylene-based polymer may have one or more of the following properties: (1) a density of about 0.85 g/cm³ to about 0.91 g/cm³ (or about 0.86 g/cm³ to about 0.91 g/cm³, or about 0.87 g/cm³ to about 0.91 g/cm³, or about 0.88 g/cm³ to about 0.905 g/cm³, or about 0.88 g/cm³ to about 0.902 g/cm³, or about 0.885 g/cm³ to about 0.902 g/cm³); (2) a heat of fusion (Hf) of about 90 J/g or less (or about 10 J/g to about 70 J/g, or about 10 J/g to about 50 J/g, or about 10 J/g to about 30 J/g); (3) a crystallinity of about 5 wt % to about 40% (or about 5 wt % to about 30%, or about 5 wt % to about 20%); (4) a melting point (Tm) of about 100° C. or less (or about 40° C. to about 100° C., or about 40° C. to about 90° C., or about 40° C. to about 80° C., or about 40° C. to about 70° C., or about 40° C. to about 60° C., or about 40° C. to about 50° C.);

(5) a crystallization temperature (Tc) of 90° C. or less (or about 30° C. to about 100° C., or about 30° C. to about 90° C., or about 30° C. to about 80° C., or about 30° C. to about 70° C., or about 30° C. to about 60° C., or about 30° C. to about 50° C., or about 30° C. to about 40° C.); (6) a glass transition temperature (Tg) of -20° C. or less (or about −50° C. to about −30° C., or about −50° C. to about −40° C.; (7) a Mw of about 30 kg/mol to about 2,000 kg/mol (or about 50 kg/mol to about 1,000 kg/mol, or about 90 kg/mol to about 500 kg/mol); (8) a Mw/Mn of about 1 to about 5 (or about 1.4 to about 4.5, or about 1.6 to about 4, or about 1.8 to about 3.5, or about 1.8 to about 2.5); and/or (9) a MFR (2.16 kg at 190° C.) of about 0.1 g/10 min to about 100 g/10 min (or about 0.3 g/10 min to about 60 g/10 min, or about 0.5 g/10 min to about 40 g/10 min, or about 0.7 g/10 min to about 20 g/10 min).

In some embodiments, the olefinic thermoplastic resin includes polypropylene. The term “polypropylene” as used herein broadly means any polymer that is considered a “polypropylene” by persons skilled in the art and includes homo, impact, and random copolymers of propylene. In at least one embodiment, the polypropylene used in the compositions described herein has a melting point above 110° C. and includes at least 90 wt % propylene-derived units. The polypropylene may also include isotactic, atactic or syndiotactic sequences, and can include isotactic sequences. The polypropylene can either derive exclusively from propylene monomers (i.e., having only propylene-derived units) or comprises at least 70 wt %, or at least 80 wt %, or at least 90 wt %, or at least 93 wt %, or at least 95 wt %, or at least 97 wt %, or at least 98 wt %, or at least 99 wt % propylene-derived units with the remainder derived from olefins, such as ethylene, and/or C4-C10 α-olefins.

The thermoplastic resin may have a melting temperature of from at last 110° C., or at least 120° C., or at least 130° C., and may be from 110° C. to 170° C. or higher, as measured by DSC.

The thermoplastic resin may have a melt flow rate “MFR” as measured by ASTM D1238 at 230° C. and 2.16 kg weight of from about 0.1 to 100 g/10 min. In some embodiments, the thermoplastic resin may have a fractional MFR, such as a polypropylene having a fractional MFR of less than about 5 g/10 min, or less than about 4 g/10 min, or less than about 3.5 g/10 min. In some embodiments, the thermoplastic resin may have a MFR of from a low of about 0.1, 0.5, 1, 1.5, 2, 2.5, or 3 g/10 min to a high of about 2.5, 3, 3.5, 4, 5, 6, 10, 15, or 45 g/10 min, where desirable ranges may include ranges from any lower limit to any upper limit.

A suitable thermoplastic resin may be a polypropylene, such as a commercially available polypropylene. Examples of suitable thermoplastic resins include, but are not limited to, “PP3155” (EXXONMOBIL™ PP 3155 polypropylene, a polypropylene homopolymer with a density of 0.9 g/cc and a melt mass-flow rate (MFR) (230° C.; 2.16 kg) of 36 g/10 min (ASTM D1238), available from ExxonMobil Chemical Company); “PP8244” (EXXONMOBIL™ PP 8244E1 polypropylene, a polypropylene impact copolymer having a density of 0.9 g/cc and a melt mass-flow rate (MFR) (230° C.; 2.16 kg) of 29.0 g/10 min (ASTM D1238), available from ExxonMobil Chemical Company); and “PP7143” (EXXONMOBIL™ PP 7143 KNE1 polypropylene, a polypropylene impact copolymer having a density of 0.9 g/cc and a melt mass-flow rate (MFR) (230° C.; 2.16 kg) of 24.5 g/10 min (ASTM D1238), available from ExxonMobil Chemical Company).

As another example thermoplastic resin, ExxonMobilTM PP 7032E2 is a polypropylene available from ExxonMobil Chemical Company. PP 7032E2 is a polypropylene impact copolymer having the following properties:
(1) a density of 0.9 g/cm³;
(2) a melt mass-flow rate (MFR) (230° C.; 2.16 kg) of 4.0 g/10 min (ASTM D1238);
(3) a tensile strength at yield 2.0 in/min (51 mm/min) of 3,480 psi (24.0 MPa) (ASTM D638);
(4) a tensile stress at yield of 3390 psi (23.4 MPa) (ISO 527-2/50);
(5) elongation at yield (2.0 in/min (51 mm/min)) of 6.4% (ASTM D638);
(6) tensile strain at yield of 6.2% (ISO 527-2/50);
(7) flexural modulus -1% secant (0.51 in/min) of 188,000 psi (1300 MPa) (ASTM D790B);
(8) notched Izod impact strength at 23° C. of 45 kJ/m² (ISO 180/1A);
(9) charpy notched impact strength at 23° C. of 48 kJ/m² (ISO 179/1eA); and
(10) heat deflection temperature (1.80 MPa) of 48.7° C. (ISO 75-2/Af).

ExxonMobil™ PP 7032E3 is a polypropylene available from ExxonMobil Chemical Company. PP 7032 E3 is a polypropylene impact copolymer having the following properties:
(1) a density of 0.9 g/cm³;
(2) a melt mass-flow rate (MFR) (230° C.; 2.16 kg) of 4.0 g/10 min (ASTM D1238);
(3) a tensile strength at yield 2.0 in/min (51 mm/min) of 3,470 psi (23.9 MPa) (ASTM D638);
(4) a tensile stress at yield of 3390 psi (23.4 MPa) (ISO 527-2/50);
(5) elongation at yield (2.0 in/min (51 mm/min)) of 7.3% (ASTM D638);
(6) tensile strain at yield of 6.3% (ISO 527-2/50);
(7) flexural modulus -1% secant (0.50 in/min) of 180,000 psi (1240 MPa) (ASTM D790B);
(8) notched Izod impact strength at 23° C. of 28 kJ/m² (ISO 180/1A);
(9) charpy notched impact strength at 23° C. of 18 kJ/m² (ISO 179/1eA); and
(10) heat deflection temperature (1.80 MPa) of 51.4° C. (ISO 75-2/A).

ExxonMobil™ PP 7032KN is a polypropylene available from ExxonMobil Chemical Company. PP 7032KN is a polypropylene impact copolymer having the following properties:
(1) a density of 0.9 g/cm³;
(2) a melt mass-flow rate (MFR) (230° C.; 2.16 kg) of 4.0 g/10 min (ASTM D1238);
(3) a tensile strength at yield 2.0 in/min (51 mm/min) of 26.1 MPa (ASTM D638);
(4) a tensile stress at yield of 26.3 MPa (ISO 527-2/50);
(5) elongation at yield (2.0 in/min (51 mm/min)) of 5.5% (ASTM D638);
(6) tensile strain at yield of 4.2% (ISO 527-2/50);
(7) flexural modulus—1% secant (1.3 mm/min) of 1,340 MPa (ASTM D790A);
(8) notched Izod impact strength at 23° C. of 42 kJ/m² (ISO 180/1A);
(9) charpy notched impact strength at 23° C. of 14 kJ/m² (ISO 179/1eA); and
(10) heat deflection temperature (1.80 MPa) of 52.5° C. (ISO 75-2/A).

ExxonMobil™ PP 7033E2 is a polypropylene available from ExxonMobil Chemical Company. PP 7033E2 is a polypropylene impact copolymer having the following properties:
(1) a density of 0.9 g/cm³;
(2) a melt mass-flow rate (MFR) (230° C.; 2.16 kg) of 8.0 g/10 min (ASTM D1238);
(3) a tensile strength at yield 2.0 in/min (51 mm/min) of 3,420 psi (ASTM D638);
(4) a tensile stress at yield of 3340 psi (ISO 527-2/50);
(5) elongation at yield (2.0 in/min (51 mm/min)) of 6.2% (ASTM D638);
(6) tensile strain at yield of 6.3% (ISO 527-2/50); and
(7) flexural modulus—1% secant (0.51 in/min) of 176,000 psi (ASTM D790B).

ExxonMobil™ PP 7033N is a polypropylene available from ExxonMobil Chemical Company. PP 7033N is a polypropylene impact copolymer having the following properties:
(1) a density of 0.9 g/cm³;
(2) a melt mass-flow rate (MFR) (230° C.; 2.16 kg) of 8.0 g/10 min (ASTM D1238);
(3) a tensile strength at yield 2.0 in/min (51 mm/min) of 3,760 psi (ASTM D638);
(4) a tensile stress at yield of 3,740 psi (ISO 527-2/50);

(5) elongation at yield (2.0 in/min (51 mm/min)) of 5.2% (ASTM D638);
(6) tensile strain at yield of 4.0% (ISO 527-2/50); and
(7) flexural modulus—1% secant (0.51 in/min) of 224,000 psi (ASTM D790B).

### Additives

Compositions of the present disclosure may include one or more additives. The additives may include reinforcing and non-reinforcing fillers, antioxidants, stabilizers, processing oils, compatibilizing agents, lubricants (e.g., oleamide), antiblocking agents, antistatic agents, waxes, coupling agents for the fillers and/or pigment, pigments, fire retardants, antioxidants, or other processing aids.

The improved melt strength and processability provided by compositions of the present disclosure can provide uniform dispersion of additives (such as fillers), if present in a composition, which provides more uniform layers (films) for roofing applications, providing improved physical properties of the layers (films). For example, additives (such as fillers) typically tend to agglomerate in a composition. However, compositions of the present disclosure promote dispersion of the additives such that additives (e.g., fillers of the present disclosure (present in a composition) have an average agglomerate size of less than 50 microns, such as less than 40 microns, such as less than 30 microns, such as less than 20 microns, such as less than 10 microns, such as less than 5 microns, such as less than 1 micron, such as less than 0.5 microns, such as less than 0.1 microns, based on a 1cm×1cm cross section of the composition as observed using scanning electron microscopy.

In some embodiments, the composition may include fillers and coloring agents. Exemplary materials include inorganic fillers such as calcium carbonate, clays, silica, talc, titanium dioxide or carbon black. Any type of carbon black can be used, such as channel blacks, furnace blacks, thermal blacks, acetylene black, lamp black and the like.

In some embodiments, the roofing composition may include fire retardants, such as calcium carbonate, inorganic clays containing water of hydration such as aluminum trihydroxides (“ATH”) or Magnesium Hydroxide. For example, the calcium carbonate or magnesium hydroxide may be pre-blended into a masterbatch with a thermoplastic resin, such as polypropylene, or a polyethylene, such as linear low density polyethylene. For example, the fire retardant may be pre-blended with a polypropylene, an impact polypropylene-ethylene copolymer, or polyethylene, where the masterbatch comprises at least 40 wt %, or at least 45 wt %, or at least 50 wt %, or at least 55 wt %, or at least 60 wt %, or at least 65 wt %, or at least 70 wt %, or at least 75 wt %, of fire retardant, based on the weight of the masterbatch. The fire retardant masterbatch may then form at least 5 wt %, or at least 10 wt %, or at least 15 wt %, or at least 20 wt %, or at least 25 wt %, of the composition. In some embodiments, the composition comprises from 5 wt % to 40 wt %, or from 10 wt % to 35 wt %, or from 15 wt % to 30 wt % fire retardant masterbatch, where desirable ranges may include ranges from any lower limit to any upper limit.

In some embodiments, the composition may include UV stabilizers, such as titanium dioxide or Tinuvin® XT-850. The UV stabilizers may be introduced into the roofing composition as part of a masterbatch. For example, UV stabilizer may be pre-blended into a masterbatch with a thermoplastic resin, such as polypropylene, or a polyethylene, such as linear low density polyethylene. For example, the UV stabilizer may be pre-blended with a polypropylene, an impact polypropylene-ethylene copolymer, or polyethylene, where the masterbatch comprises at least 5 wt %, or at least 7 wt %, or at least 10 wt %, or at least 12 wt %, or at least 15 wt %, of UV stabilizer, based on the weight of the masterbatch. The UV stabilizer masterbatch may then form at least 5 wt %, or at least 7 wt %, or at least 10 wt %, or at least 15 wt %, of the composition. In some embodiments, the composition comprises from 5 wt % to 30 wt %, or from 7 wt % to 25 wt %, or from 10 wt % to 20 wt % fire retardant masterbatch, where desirable ranges may include ranges from any lower limit to any upper limit.

Still other additives may include antioxidant and/or thermal stabilizers. In an exemplary embodiment, processing and/or field thermal stabilizers may include IRGANOX® B-225 and/or IRGANOX® 1010 available from BASF.

### End Uses

Compositions of the present disclosure can be particularly useful for roofing applications, such as for thermoplastic polyolefin roofing membranes. Membranes produced from the compositions may exhibit a beneficial combination of properties, and in particular exhibit an improved balance of elastic modulus (flexibility) at temperatures from −40° C. to 40° C., elastic modulus at elevated temperatures (e.g., 100° C.) (an attribute that mitigates roll blocking), and higher melt strength (that provides improved dimensional stability in a sheeting process).

The roofing compositions described herein may be made either by pre-compounding or by in-situ compounding using polymer-manufacturing processes such as Banbury mixing or twin screw extrusion. The compositions may then be formed into roofing membranes. The roofing membranes may be particularly useful in commercial roofing applications, such as on flat, low-sloped, or steep-sloped substrates.

The roofing membranes may be adhered to or affixed to the base roofing by any suitable fastening means such as via adhesive material, ballasted material, spot bonding, or mechanical spot fastening. For example, the membranes may be installed using mechanical fasteners and plates placed along the edge sheet and fastened through the membrane and into the roof decking. Adjoining sheets of the flexible membranes are overlapped, covering the fasteners and plates, and may be joined together, for example with a hot air weld. The membrane may also be fully adhered or self-adhered to an insulation or deck material using an adhesive. Insulation is typically secured to the deck with mechanical fasteners and the flexible membrane is adhered to the insulation.

The roofing membranes may be reinforced with any type of scrim including, but not limited to, polyester, fiberglass, fiberglass reinforced polyester, polypropylene, woven or non-woven fabrics (e.g., Nylon) or combinations thereof. For example, a scrim can be fiberglass and/or polyester.

In some embodiments, a surface layer of the top and/or bottom of the membrane may be textured with various patterns. Texture increases the surface area of the membrane, reduces glare and makes the membrane surface less slippery. Examples of texture designs include, but are not limited to, a polyhedron with a polygonal base and triangular faces meeting in a common vertex, such as a pyramidal base; a cone configuration having a circular or ellipsoidal configurations; and random pattern configurations.

In at least one embodiment, a roofing membrane has a thickness of from 0.1 to 5 mm, or from 0.5 to 4 mm

A composition of the present disclosure can include a blend composition of a propylene-based elastomer, thermoplastic resin, at least one fire retardant, and at least one ultraviolet stabilizer. In some embodiments, the blend composition further comprises a polyalphaolefin.

In at least one embodiment, a membrane may be fabricated as a composite structure containing a reflective membrane (40 to 60 mils thick) (1 to 1.5 mm thick), a reinforcing layer (1 to 2 mils thick) (0.03 to 0.05 mm thick), and a pigmented layer (40 to 60 mils thick) (1 to 1.5 mm thick). A reflective membrane can be a thermoplastic compounded with white fillers, such as titanium dioxide. A reinforcing layer may have a polyester fiber scrim. A pigmented layer may have a thermoplastic compounded with carbon black.

### Embodiments Listing

The present disclosure provides, among others, the following embodiments, each of which may be considered as optionally including any alternate embodiments.
Clause 1. A roofing composition, comprising:
   a polymer blend, comprising:
      a propylene-based elastomer, wherein the propylene-based elastomer has a melt flow rate of less than about 3 g/10 min, according to ASTM D-1238 (2.16 kg weight @ 230° C.); and
      a thermoplastic resin;
   a UV stabilizer; and
   a fire retardant.
Clause 2. The roofing composition of Clause 1, wherein the propylene-based elastomer has: an Mw of about 300,000 g/mol to about 600,000 g/mol.
Clause 3. The roofing composition of any of Clauses 1-2, wherein the propylene-based elastomer has at least one of the following properties:
   an Mw of from about 500,000 g/mol to about 600,000 g/mol,
   a melt flow rate of from about 0.1 dg/min to about 2 dg/min, according to ASTM 1238 (2.16 kg @ 230° C.),
   a percent crystallinity that less than about 3,
   a density of from about 0.85 g/cm³ to about 0.87 g/cm³, according to ASTM D-1505,
   a melt index of from about 0.5 g/10 min to about 3.0 g/10 min, according to ASTM D-1238 (2.16 kg@230° C.), and
   a number average molecular weight (Mn) of from about 150,000 g/mol to about 350,000 g/mol.
Clause 4. The roofing composition of any of Clauses 1-3, wherein the propylene-based polymer is made using a catalyst system comprising:
   an activator, and
   a quinolinyldiamo catalyst.
Clause 5. The roofing composition of any of Clauses 1-3, wherein the propylene-based polymer is formed using a catalyst system comprising:
   an activator, and
   a catalyst comprising a group 4 bis(phenolate) complex.
Clause 6. The roofing composition of any of Clauses 1-5, wherein the polymer blend comprises from 8 to 15 wt % ethylene, based on the total weight of the polymer blend.
Clause 7. A roofing composition, comprising:
   a polymer blend, comprising:
      a propylene-based elastomer, wherein the propylene-based elastomer has a branching index, g′, less than 1, according to GPC-4D; and
      a thermoplastic resin;
   a UV stabilizer; and
   a fire retardant.
Clause 8. The roofing composition of Clause 7, wherein the propylene-based polymer comprises:
   at least 60 wt % propylene-derived units;
   from 0.3 to 10 wt % diene-derived units; and
   at least 6 wt % ethylene-derived units,
   wherein the wt % of each is based on the total weight of the propylene-based elastomer, and
   wherein the propylene-based elastomer has isotactic polypropylene crystallinity, a melting point by DSC equal to or less than 110° C., and a heat of fusion of from 5 J/g to 50 J/g.
Clause 9. The roofing composition of Clause 8, wherein the diene is 5-vinyl-2-norbornene (VNB).
Clause 10. The roofing composition of any of Clauses 7-9, wherein the propylene-based elastomer is partially insoluble and the fractions soluble at 23° C. and 31° C., as measured by the extraction method described herein, have ethylene contents differing by 5 wt % or less.
Clause 11. The roofing composition of claim 7, wherein the propylene-based elastomer is a branched propylene-based elastomer formed by a process comprising:
   combining a first propylene-based elastomer, a free radical initiator, and a coagent in a mixer to form the branched propylene-based elastomer.
Clause 12. The roofing composition of Clause 11, wherein the process further comprises:
   adding a radical trapping agent to the first propylene-based polymer prior to adding either the coagent or the free radical initiator.
Clause 13. The roofing composition of Clause 12, wherein the radical trapping agent comprises:
   at least one nitroxide radical; and
   at least one unsaturated bond capable of undergoing radical reaction.
Clause 14. The roofing composition of any of Clauses 12-13, wherein the radical trapping agent is 4-Acryloyloxy-2,2,6,6-tetramethylpiperidine-N-oxyl, (AOTEMPO).
Clause 15. The roofing composition of any of claims 11-14, wherein the free radical initiator is selected from the group consisting of organic peroxides, organic peresters, and azo compounds. Examples of such compounds include benzoyl peroxide,
   dichlorobenzoyl peroxide, dicumyl peroxide, di-tert-butyl peroxide, 2,5-dimethyl-2,5-di(peroxybenzoate)hexyne-3,1,4-bis(tert-butylperoxyisopropyl)benzene,
   lauroyl peroxide, tert-butyl peracetate, 2,5-dimethyl-2,5-di(tert-butylperoxy)hexyne-3,2,5-dimethyl-2,5-di(tert-butylperoxy)hexane, tert-butyl perbenzoate, tert-butylperphenyl acetate, tert-butyl perisobutyrate, tert-butyl per-sec-octoate, tert-butyl perpivalate, cumyl perpivalate and tert-butyl perdiethylacetate, azoisobutyronitrile, dimethyl azoisobutyrate.
Clause 16. The roofing composition of any of Clauses 11-15, wherein the free radical initiator is 2,5-dimethyl-2,5-di(tert-butylperoxy)hexane.
Clause 17. The roofing composition of any of Clauses 11-16, wherein the coagent is selected from the group consisting of triallylcyanurate, triallyl isocyanurate, triallyl phosphate, sulfur, N-phenyl bis-maleamide, zinc diacrylate, zinc dimethacrylate, divinyl benzene, 1,2 polybutadiene, trimethylol propane trimethacrylate, tetramethylene glycol diacrylate, trifunctional acrylic ester, dipentaerythritolpentacrylate, polyfunctional acrylate, retarded cyclohexane dimethanol diacrylate ester, polyfunctional methacrylates, acrylate and methacrylate metal salts, oximer for e.g., quinone dioxime.
Clause 18. The roofing composition of any of Clauses 11-17, wherein the coagent is triallyl isocyanurate.
Clause 19. Clause The roofing composition of any of Clauses 12-14, wherein the branched propylene-based elastomer is formed from 95 to 99 wt % first propylene-based elastomer, 0.5 to 1 wt % radical trapping agent, 0.3 to 0.6 wt % coagent, and 0.5 to 1.5 wt % free radical initiator, wherein the wt % is based on the total weight of the branched propylene-based elastomer.
Clause 20. A roofing composition, comprising:
   a propylene-based elastomer-graft-polystyrene (PBE-g-PS) at about 20 wt % to about 50 wt % by weight of the TPO membrane;
   a thermoplastic resin at about 5 wt % to about 50 wt % by weight of the roofing composition;
   a UV stabilizer; and
   a fire retardant.
Clause 21. The roofing composition of Clause 20, wherein the propylene-based elastomer of the PBE-g-PS has 70 wt % to 95 wt % of propylene-derived units and 5 wt % to 30 wt % of C2 or C4-C6 α-olefin-derived units.
Clause 22. The roofing composition of any of Clauses 20-21, wherein the PBE-g-PS has at least one of the following properties:
   a styrene content of about 1 wt % to about 40 wt %,
   a melt flow rate of about 1 g/10 min to about 20 g/10 min according to ASTM D1238 (2.16 kg @230° C.),
   a weight average molecular weight of about 100,000 g/mol to about 500,000 g/mol,
   a number average molecular weight of about 5,000 g/mol to about 50,000 g/mol, and
   a molecular weight distribution of about 3 to about 20.
Clause 23. The roofing composition of any of Clauses 1-22, wherein the roofing composition includes about 5 wt % to about 50 wt % of the thermoplastic resin, based on the total weight of the roofing membrane.
Clause 24. The roofing composition of any of Clauses 1-23 wherein the thermoplastic resin is a polypropylene.
Clause 25. The roofing composition of Clause 24, wherein the polypropylene comprises a comonomer and at least 85 wt propylene-derived units.
Clause 26. The roofing composition of Clause 25, wherein the comonomer is ethylene.
Clause 27. The roofing composition of any of Clauses 1-26, wherein the thermoplastic resin is an impact copolymer.
Clause 28. The roofing composition of any of Clauses 1-27, wherein the thermoplastic resin has a melting temperature of from about 110° C. to about 170° C., as measured by DSC.
Clause 29. The roofing composition of any of Clauses 1-28, wherein the thermoplastic resin has a melt flow rate of from about 0.1 to about 4, according to ASTM D1238 (2.16 kg weight @ 230° C.).
Clause 30. The roofing composition of any of Clauses 1-29, wherein the thermoplastic resin is a polypropylene having the following properties:
   (1)a density of about 0.9 g/cm³;
   (2)a melt flow rate (MFR) of about 4 g/10 min, according to ASTM D1238 (2.16 kg weight @ 230° C.);
   (3)a tensile strength at yield of about 3,500 psi (about 24 MPa), according to ASTM D638 (2.0 in/min; 51 mm/min);
   (4)a tensile stress at yield of about 3390 psi (23.4 MPa), according to ISO 527-2/50;
   (5)elongation at yield of about 6.4%, according to ASTM D638 (2.0 in/min; 51 mm/min);
   (6)tensile strain at yield of about 6.2%, according to ISO 527-2/50;
   (7)flexural modulus of about 188,000 psi (about 1300 MPa), according to ASTM D790B (1% secant; 0.51 in/min);
   (8)notched Izod impact strength of about 45 kJ/m², according to ISO 180/1A (23° C.);
   (9)charpy notched impact strength of about 48 kJ/m², according to ISO 179/1eA (23° C.); and
   (10) heat deflection temperature of about 48.7° C., according to ISO 75-2/Af (1.80 MPa).
Clause 31. The roofing composition of any of Clauses 1-29, wherein the thermoplastic resin is a polypropylene having the following properties:
   (1)a density of about 0.9 g/cm³;
   (2)a melt flow rate (MFR) of about 4 g/10 min, according to ASTM D1238 (230° C.; 2.16 kg);
   (3)a tensile strength at yield of about 3,470 psi (about 23.9 MPa), according to ASTM D638 (2.0 in/min; 51 mm/min);
   (4)a tensile stress at yield of about 3390 psi (about 23.4 MPa), according to ISO 527-2/50;
   (5)elongation at yield of about 7.3%, according to ASTM D638 (2.0 in/min; 51 mm/min);
   (6)tensile strain at yield of about 6.3%, according to ISO 527-2/50;
   (7)flexural modulus of about 180,000 psi (about 1240 MPa), according to ASTM D790B (1% secant; 0.50 in/min);
   (8)notched Izod impact strength of about 28 kJ/m², according to ISO 180/1A (23° C.);
   (9)charpy notched impact strength of about 18 kJ/m², according to ISO 179/1eA (23° C.); and
   (10) heat deflection temperature of about 51.4° C., according to ISO 75-2/A (1.80 MPa).
Clause 32. The roofing composition of any of Clauses 1-29, wherein the thermoplastic resin is a polypropylene having the following properties:
   (1)a density of about 0.9 g/cm³;
   (2)a melt flow rate (MFR) of about 4 g/10 min, according to ASTM D1238 (230° C.; 2.16 kg);
   (3)a tensile strength at yield of about 26.1 MPa, according to ASTM D638 (2.0 in/min; 51 mm/min);
   (4)a tensile stress at yield of about 26.3 MPa, according to ISO 527-2/50;
   (5)elongation at yield of about 5.5%, according to ASTM D638 (2.0 in/min; 51 mm/min);
   (6)tensile strain at yield of about 4.2%, according to ISO 527-2/50;
   (7)flexural modulus of about 1,340 MPa, according to ASTM D790B (1% secant; 0.50 in/min);
   (8)notched Izod impact strength of about 42 kJ/m², according to ISO 180/1A (23° C.);
   (9)charpy notched impact strength of about 14 kJ/m², according to ISO 179/1eA (23° C.); and
   (10) heat deflection temperature of about 52.5° C., according to ISO 75-2/A (1.80 MPa).
Clause 33. The roofing composition of Clause 1, wherein the propylene-based elastomer has at least one of the following properties:
   a heat of fusion less than 25 J/g,
   a density of 0.862 g/cm³, according to ASTM D1505,
   a melt index of 1.4 g/10 min (190° C/2.16 kg),
   a melt flow rate of 3 g/10 min, according to ASTM D1238 (230° C.; 2.16 kg),
   an ethylene content of 16 wt %,
   tensile strength at break of greater than 1,100 psi, according to ASTM D638,
   elongation at break of greater than 800%, according to ASTM D638, and
   flexural modulus 1% secant of 2,090 psi, according to ASTM D790.
Clause 34. A roofing composition, comprising:
   a polymer blend, comprising:
      a propylene-based elastomer; and
      a thermoplastic polyolefin;
   a UV stabilizer; and
   a fire retardant.
Clause 35. The roofing composition of Clause 34, wherein the roofing composition has a phase angle at a complex modulus G* of 1,000 Pa of about 73 or less.
Clause 36. The roofing composition of any of claims 34-35, wherein the roofing composition has a phase angle at a complex modulus G* of 500 of about 72 or less.
Clause 37. The roofing composition of any of Clauses 34-36, wherein the roofing composition has an extensional viscosity at Henchy rate of 1s⁻¹ at 0.1 sec that is at least 50% greater than the extensional viscosity of a control sample at 0.1 sec, and wherein the roofing composition has an extensional viscosity at Henchy rate of 1s⁻¹ at 1.0 sec that is at least 100% greater than the extensional viscosity of the control sample at 1 sec, and
   wherein the control sample has a composition identical to the roofing composition, except that the first polyolefin is a propylene-based polymer having the following properties:
      a heat of fusion less than 25 J/g,
      a density of 0.862 g/cm³, according to ASTM D1505,
      a melt index of 1.4 g/10 min (190° C/2.16 kg),
      a melt flow rate of 3 g/10 min, according to ASTM D1238 (230° C.; 2.16 kg),
      an ethylene content of 16 wt %,
      a tensile strength at break of greater than 1,100 psi, according to ASTM D638,
      a elongation at break of greater than 800%, according to ASTM D638, and
      a flexural modulus 1% secant of 2,090 psi, according to ASTM D790, and
   the second polyolefin is a thermoplastic resin having the following properties:
      a density of 0.9 g/cm³;
      a melt mass-flow rate (MFR) (230° C.; 2.16 kg) of 4.0 g/10 min (ASTM D1238);
      a tensile strength at yield 2.0 in/min (51 mm/min) of 3,480 psi (24.0 MPa) (ASTM D638);
      a tensile stress at yield of 3390 psi (23.4 MPa) (ISO 527-2/50);
      a elongation at yield (2.0 in/min (51 mm/min)) of 6.4% (ASTM D638);
      a tensile strain at yield of 6.2% (ISO 527-2/50);
      a flexural modulus—1% secant (0.51 in/min) of 188,000 psi (1300 MPa) (ASTM D790B);
      a notched Izod impact strength at 23° C. of 45 kJ/m² (ISO 180/1A);
      a charpy notched impact strength at 23° C. of 48 kJ/m² (ISO 179/1eA); and
      a heat deflection temperature (1.80 MPa) of 48.7° C. (ISO 75-2/Af).
Clause 38. The roofing composition of any of Clauses 34-37, wherein the roofing composition has an extensional viscosity at Henchy rate of 1s⁻¹ at 0.1 sec that is greater than 15,000 Pa-sec, when measured by the US-EV method.
Clause 39. The roofing composition of any of Clauses 34-38, wherein the roofing composition has an extensional viscosity at Henchy rate of 1s⁻¹ at 1 sec that is greater than 40,000 Pa-sec, when measured by the US-EV method.
Clause 40. he roofing composition of any of Clauses 34-39, wherein the roofing composition comprises from 30 to 70 wt % of the polymer blend, based on the total weight of the roofing composition.
Clause 41. The roofing composition of any of Clauses 34-40, wherein the polymer blend comprises from 30 to 70 wt % of the first polyolefin, based on the total weight of the polymer blend.
Clause 42. The roofing composition of any of Clauses 34-41, wherein the polymer blend comprises from 30 to 70 wt % of the second polyolefin, based on the total weight of the polymer blend
Clause 43. The roofing composition of any of Clauses 34-42, wherein the first polyolefin is a propylene-based elastomer.
Clause 44. The roofing composition of any of Clauses 34-43, wherein the second polyolefin is an impact copolymer comprising a polypropylene matrix phase and an ethylene-propylene rubber dispersed phase.
Clause 45. A roofing material, comprising:
   a membrane comprising the roofing composition of any of Clauses 1 to 44; and
   a base material adhered to or affixed to the membrane.
Clause 46. The roofing material of Clause 45, wherein the membrane further comprises a scrim selected from the group consisting of polyester, fiberglass, fiberglass reinforced polyester, polypropylene, woven or non-woven fabrics, and combination(s) thereof.
Clause 47. The roofing material of any of Clauses 44 to 46, wherein the membrane has a thickness of from about 0.5 mm to about 4 mm
Clause 48. A method comprising:
   blending a composition comprising:
   a propylene-based elastomer, wherein the propylene-based elastomer has a melt flow rate of less than about 3 g/10 min, according to ASTM D-1238 (2.16 kg weight @ 230° C.);
   a thermoplastic resin;
   a UV stabilizer; and
   a fire retardant.

### EXAMPLES

To solve the dimensional stability required in the sheeting process, polypropylene homopolymer (HPP) with propylene-based elastomer with C2% ranging from 10 wt % to 20 wt % were blended, which provided high melt strength and softness in the TPO roofing formulations. Compared to Vistamaxx 6102 polymer, propylene-based elastomers tested provided enhanced melt strength. Such formulations had a similar elastic modulus, compared to the Vistamaxx 6102 formulation, to provide softness.

### I. High Molecular Weight Propylene-based Elastomer

The test methods used in the Examples are listed in Table 1 below.

TABLE 1

| Property Tested | Test Method |
|---|---|
| Melt Flow Rate | ASTM D1238 |
| Density | ASTM D1505 |
| Tensile Stress at Yield | ASTM D638 |
| Tensile Stress at Break | ASTM D638 |
| Tensile Strain at Break | ASTM D638 |
| Tensile Modulus 1% Secant | ASTM D638 |
| Flexural Modulus 1% Secant | ASTM D790 |
| DMTA: E′ | (Described Below) |

Dynamic Mechanical Thermal Analysis (“DMTA”) tests were conducted on samples made in the Examples to provide information about the small-strain mechanical response of the sample as a function of temperature. Sample specimens were tested using a commercially available DMA instrument (e.g., TA Instruments DMA 2980 or Rheometrics RSA) equipped with a dual cantilever test fixture. The specimen was cooled to −70° C. and then heated to 100° C. at a rate of 2° C./min while being subjected to an oscillatory deformation at 0.1% strain and a frequency of 6.3 rad/sec. The output of the DMTA test is the storage modulus (E′) and the loss modulus (E″). The storage modulus indicates the elastic response or the ability of the material to store energy, and the loss modulus indicates the viscous response or the ability of the material to dissipate energy. The ratio of E″/E′, called Tan-Delta, gives a measure of the damping ability of the material; peaks in Tan Delta are associated with relaxation modes for the material.

MFR is determined as follows: g/10min. At 230 degree C., 2.16kg polymer is loaded into a die with size of L/D (8.000mm/2.095mm). Weight in grams that comes through this die during 10 min with a constant temperature is measured.

Ethylene content is determined as follows: Fourier Transform Infrared Spectroscopy (FTIR): Sample was pressed into a film with thickness of 100-200 microns between 2 sheets of Teflon paper under 150° C. FTIR spectroscopic imaging was performed using PerkinElmer Spectrum 100 Series Spectrometers. The spectral resolution was 4 cm⁻¹, and the cumulative number of scans was 16 for each measurement. Te spectral range of the infrared spectra was from 4000 cm⁻¹ to 450cm⁻¹. The scan speed was 0.2 cm/s.

Extensional Viscosity is determined as follows: The transient uniaxial extensional viscosity was measured using an Anton-Paar MCR 501 or TA Instruments DHR-3 using a SER Universal Testing Platform (Xpansion Instruments, LLC), model SER2-P, SER3-G, or SER-2-A. The SER Testing Platform was used on a Rheometrics ARES-LS (RSA3) strain-controlled rotational rheometer available from TA Instruments Inc., New Castle, Del., USA. The SER (Sentmanat Extensional Rheometer) Testing Platform is described in U.S. Pat. Nos. 6,578,413 & 6,691,569, which are incorporated herein for reference. A general description of transient uniaxial extensional viscosity measurements is provided, for example, in “Strain hardening of various polyolefins in uniaxial elongational flow”, The Society of Rheology, Inc., J. Rheol. 47(3), 619-630 (2003); and “Measuring the transient extensional rheology of polyethylene melts using the SER universal testing platform”, The Society of Rheology, Inc., J. Rheol. 49(3), 585-606 (2005), incorporated herein for reference.

Hifax™ CA 10 A is a reactor TPO (thermoplastic polyolefin) manufactured using the LyondellBasell proprietary Catalloy process technology. It is suitable for industrial applications where a combination of good processability and excellent softness is required. It is widely used as building block resin for flexible water-proofing membranes. Hifax CA 10 A exhibits low stiffness, low hardness and good impact resistance. Hifax CA 10 A has the following properties:
Density, ISO 1183-1, method A of 0.880 g/cm³
Melt Flow, ISO 1133-1 of 0.60 g/10 min
Hardness, Shore D, ISO 868 of 30 @ time 15 seconds
Tensile Strength at Break, ISO 527-1,-2 of 11 MPa
Elongation at Break, ISO 527-1,-2 of 500%
Flexural Modulus, ISO 178 0.09 GPa
Charpy Impact, Notched, ISO 179, failure mode-partial break, of 11 J/cm² at -20° C.
Deflection Temperature at 0.46 MPa (66 psi), ISO 75B-1,-2, unannealed of 40° C.
Vicat Softening Point, ISO 306, A50 of 60° C.
DSC Induction Temperature, ISO 11357-3 of 142° C.
Ethylene content of 19 wt %

Vistamaxx™ 6100 is a propylene-based elastomer available from ExxonMobil Chemical Company. Vistamaxx™ 6100 has a density of 0.855 g/cm³ (ASTM D1505), a melt index (190° C/2.16 kg) of 3 g/10 min, a melt flow rate of 3 g/10 min (ASTM D1238), and an ethylene content of 16 wt %, tensile strength at break (ASTM D638) of greater than 2,130 psi, elongation at break (ASTM D638) of greater than 860%, and flexural modulus 1% secant (ASTM D790) of 2,770 psi.

Vistamaxx™ 6102 is a propylene-based elastomer available from ExxonMobil Chemical Company. Vistamaxx^{TM} 6102 has a density of 0.862 g/cm³ (ASTM D1505), a melt index (190° C/2.16 kg) of 1.4 g/10 min, a melt flow rate of 3 g/10 min, an ethylene content of 16 wt %, tensile strength at break (ASTM D638) of greater than 1,100 psi, elongation at break (ASTM D638) of greater than 800%, flexural modulus 1% secant (ASTM D790) of 2,090 psi.

“PP7032” is ExxonMobilTM PP 7032E2, a polypropylene available from ExxonMobil Chemical Company. PP7032 is a polypropylene impact copolymer having a density of 0.9 g/cc, a melt flow rate (MFR) (230° C.; 2.16 kg) of 4.0 g/10 min (ASTM D1238) and an ethylene content of 9 wt %.

The Magnesium Hydroxide Masterbatch used in the examples was Vertex™ 60 HST from J. M Huber. It contains 70 wt % magnesium hydroxide and 30 wt % of a polypropylene impact copolymer AdflexTM KS 311P from Lyondell Basell.

The White Concentrate Masterbatch used in the examples contains greater than 50 wt % titanium dioxide, with the rest being polypropylene homopolymer.

The UV Stabilizer Masterbatch used in the examples was a masterbatch containing UV stabilizing additives, titanium-dioxide as the white pigment, and a carrier resin, the masterbatch having a density of 1.04 g/cc.

Table 2 shows the raw materials that includes both polymers and additives used in the roofing formulations. In Table 2, Exp. 1, Exp. 2, and Exp. 3 are high MW propylene-based elastomers made using a hafnium quinolinyl diamido catalyst (as shown above in Formula II and described in U.S. Publication No. 2018/0002352) and having an MFR at around 0.5 g/10min. VistamaxxTM 6100 propylene-based elastomer is a single reactor PBE without an RCP component. Comparative formulations were produced using Vistamaxx™ 6102 propylene-based elastomer and Hifax™ CA 10 A.

TABLE 2

| | C2 | MFR | Density | % |
|---|---|---|---|---|
| Component | (wt %) | (g/10 min) | (g/cc) | Filler |
| VM 6102 | 16 | 3 | 0.862 | |
| VM 6100 | 16 | 3 | 0.862 | |
| Exp. 1 | 9 | 0.46 | 0.862 | |
| Exp. 2 | 19.2 | 0.47 | 0.862 | |
| Exp. 3 | 12.3 | 0.49 | 0.862 | |
| PP 7032 | 9 | 3 | 0.900 | |
| CA 10 A | 19 | 0.5 | 0.880 | |
| MgOH₂ Masterbatch | | | 1.920 | 30.0 |
| UV Stabilizer Masterbatch | | | 1.000 | 3.0 |
| White concentrate | | | 1.000 | 7.0 |
| Masterbatch | | | | |

Table 3 shows TPO formulations. Example C1 C2 and C3 are controls. Example C3 contains Hifax™ CA 10 A, while example C1 and C2 contains Vistamaxx™ 6102 and 6100 PBE. The flexural modulus of the inventive formulations of Examples 1 to 3 is lower than both examples C1 and C2. In Table 3, “Tan Delta Peak” is the temperature associated to the turning point of Tan Delta curve. This temperature usually is negative, also known as glass transition temperature of the composition, while the whole Tan Delta curve value (which is the ratio of positive number viscous modulus E″ to positive number elastic modulus E′) is positive.

The formulations were compounded in the Intelli-torque Brabender using a melt temperature of 210° C. For this experiment, the CWB Prep-Mixer was used for around 250g of materials and then the polymer and fillers were introduced directly into the extruder hopper. Mixing was completed 3 minutes after homogenization when the torque stabilized. The batch weight of the formulation was 250 gm.

TABLE 3

| Example | | C1 | C2 | Example 1 |
|---|---|---|---|---|
| Vistamaxx 6102 | | 30.0 | | |
| Vistamaxx 6100 | | | 30.0 | |
| Exp. 1 | | | | 30.0 |
| Exp. 2 | | | | |
| Exp. 3 | | | | |
| PP 7032 | | 30.0 | 30.0 | 30.0 |
| CA 10 A | | | | |
| MgOH₂ Masterbatch | | 30.0 | 30.0 | 30.0 |
| UV Stabilizer | | 3.0 | 3.0 | 3.0 |
| Masterbatch | | | | |
| White concentrate | | 7.0 | 7.0 | 7.0 |
| masterbatch | | | | |
| Total | | 100 | 100 | 100 |
| MFR | | 5.88 ± 0.82 | 5.62 ± 0.83 | 1.04 ± 0.02 |
| Tan delta Peak | C. | −30.2 | −27.9 | −13.5 |
| E″ Peak | C. | −31.9 | −30.2 | −17.8 |
| Flex Modulus | MPa | 479 | 410 | 431 |
| Flex Mod. (std dev) | | 22.8 | 16.3 | 13.5 |
| 1% Secant Modulus | MPa | 489.92 | 415.90 | 490.79 |
| Example | | Example 2 | Example 3 | C3 |
| Vistamaxx 6102 | | | | |
| Vistamaxx 6100 | | | | |
| Exp. 1 | | | | |
| Exp. 2 | | 30.0 | | |
| Exp. 3 | | | 30.0 | |
| PP 7032 | | 30.0 | 30.0 | |
| CA 10 A | | | | 60.0 |
| MgOH₂ Masterbatch | | 30.0 | 30.0 | 30.0 |
| UV Stabilizer | | 3.0 | 3.0 | 3.0 |
| Masterbatch | | | | |
| White concentrate | | 7.0 | 7.0 | 7.0 |
| masterbatch | | | | |
| Total | | 100 | 100 | 100 |
| MFR | | 1.25 ± 0.01 | 0.95 ± 0.01 | 0.93 ± 0.01 |
| Tan delta Peak | C. | −32.1 | −24.7 | −28.3 |
| E″ Peak | C. | −32.1 | −26.5 | −32.0 |
| Flex Modulus | MPa | 382 | 358 | 227 |
| Flex Mod. (std dev) | | 16.4 | 15.4 | 11.1 |
| 1% Secant Modulus | MPa | 360.00 | 361.63 | 235.43 |

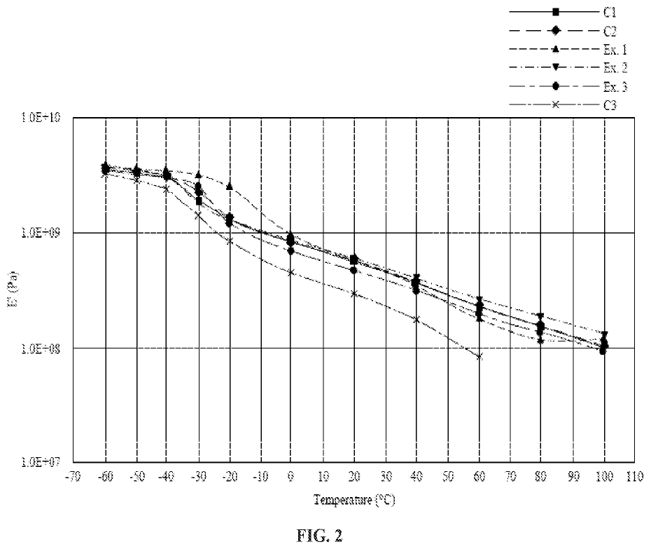

FIG. 2 is a graph illustrating Elastic modulus, E, versus temperature of the compositions. The inventive compositions of Examples 1 to 3 display equivalent modulus to example C1 and C2 at temperatures below −40° C. and similar modulus in the temperature range of −40° C. to 40° C., and at higher temperatures the modulus values approach that of control examples Cl and C2, and much higher than control example C3, indicating enhanced modulus at elevated temperature with respect to the control example C3.

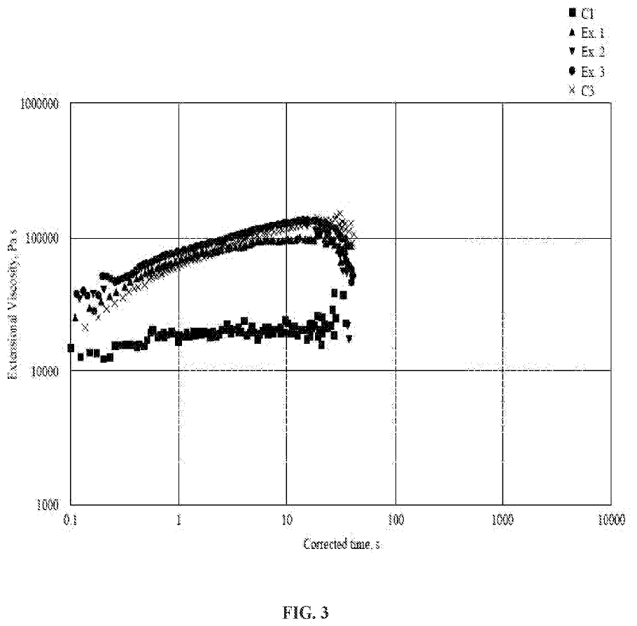

FIG. 3 is a graph illustrating extensional viscosity of the five compositions. Extensional test was conducted at 190° C. on ARES instrument with extensional viscosity fixture (EVF), Hencky rate is set at 0.1/s. A nitrogen atmosphere was used to avoid oxidative degradation. Compared to control example C1, the inventive formulations of Examples 1 to 3 display much higher melt strength, which is equivalent to control example C3. This indicates the inventive formulations of Examples 1 to 3 provide the processability parameters for TPO roofing applications.

### II. Fractional MFR Propylene-Based Elastomers

Table 4 shows the raw materials that includes both polymers and additives used in the roofing formulations. Exp. 4 is a fractional MFR propylene-based elastomer made using a catalyst comprising a group 4 bis(phenolate) complex (as shown above in Formula III and described in PCT Application No. PCT/US2020/045819) and having an MFR around 0.9 g/10 min. Conc. 80 is a Fire Retardant Masterbatch including 80 wt % fire retardant. Conc. 27 UHP is a UV Stablizer Masterbatch including 27 wt % UV stabilizer.

TABLE 4

| | C2 | MFR | Density | % |
|---|---|---|---|---|
| Component | (wt %) | (g/10 min) | (g/cc) | Filler |
| VM 6102 | 16 | 3 | 0.862 | |
| Exp. 4 | 16 | 0.88 | N/A | |
| PP 7032 | 9 | 3 | 0.900 | |
| HifaxTM CA 10 A | 19 | 0.5 | 0.880 | |
| Conc. 80 | | | NA | 20% |
| (Fire Retardant Masterbatch) | | | | |
| Conc. 27 UHP (UV | | | NA | 73% |
| Stablizer Masterbatch) | | | | |

Table 5 shows TPO formulations in grams. Examples C4, C5 and C6 are controls. Example C4 contains Hifax™ CA 10 A, while examples C5 and C6 contain Vistamaxx™ 6100 PBE. The formulations were compounded in the Intelli-torque Brabender using a melt temperature of 200° C. at a low RPM to flux and then mixed at 50 RPM for 3 minutes. The batch weight of each formulation was about 270 g.

TABLE 5

| | | | | Example 4 |
|---|---|---|---|---|
| | C4 | C5 | C6 | (E4) |
| Hifax CA10A | 153 | | | |
| Vistamaxx 6100 | | 75 | 75 | |
| Exp. 4 | | | | 75 |
| PP 7032 | | 75 | | 75 |
| Braskem TI 4007 | | | 75 | |
| G | | | | |
| Conc. 80 | 76 | 75 | 75 | 75 |
| Conc 27 UHP | 44 | 43 | 43 | 43 |
| Total [g] | 273 | 269 | 269 | 269 |
| MFR | 1.09 | 3.7 | 2.0 | 0.8 |
| Tan delta Peak | −26.7 | −27.3 | −27.3 | −213 |
| Flex Modulus | 166 | 315 | 328 | 304 |
| Flex Mod. (std | 25.4 | 22 | 45 | 11.2 |
| dev) | | | | |

The flexural modulus of the inventive formulation of Example 4 is lower than both examples C5 and C6.

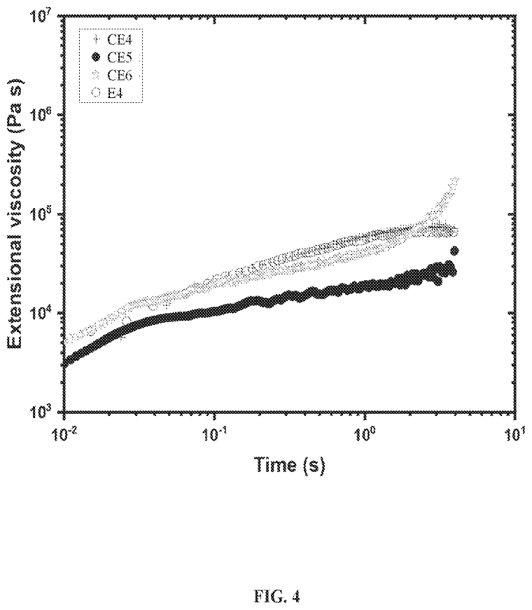

FIG. 4 is a graph illustrating extensional viscosity of the four compositions. The US-EV method described above was used. Compared to control examples C5 and C6, the inventive formulation of Example 4 displays much higher melt strength, which is equivalent to control example C4. This indicates the inventive formulation of Example 4 provides the processability parameters for TPO roofing applications.

Table 6 provides extensional viscosity data for controls C4, C5, and C6 and inventive Example 4. At small corrected times, i.e. 0.001 seconds, the test method may have high levels of noise. At greater corrected times, where extensional viscosity measurements are more consistent and accurate, it can be seen that inventive Example 4 performs comparably to control sample C4, and much greater than PBE control compositions C5 and C6.

TABLE 6

| Corrected time [s] | C4 | C5 | C6 | E4 |
|---|---|---|---|---|
| 0.001 | NA | 284.2 | 3281.7 | 854.1 |
| 0.01 | 3086.0 | 3383.3 | 5506.8 | 6537.3 |
| 0.1 | 24228.2 | 10435.9 | 20276.9 | 21958.3 |
| 1 | 58866.7 | 19290.0 | 41582.9 | 54747.8 |

Table 7 illustrates the percentage increase in extensional viscosity for inventive Example 4 as compared to control sample C5. Sample C5 includes a PBE having an MFR of 3 as compared to the inventive Example 4, which includes a PBE having a fractional MFR of 0.88. Achieving a PBE having a lower MFR (e.g., less than 1) corresponds to extensional viscosity improvements of roughly 100% or more across the test range. This further supports that the inventive formulation of Example 4 provides the processability parameters for TPO roofing applications.

TABLE 7

| Corrected time [s] | E4 |
|---|---|
| 0.001 | 201% |
| 0.01 | 93% |
| 0.1 | 110% |
| 1 | 184% |

### III. PBE-VBN Terpolymers

Table 8 shows the raw materials that includes both polymers and additives used in the roofing formulations. Exp. 5, Exp. 6, and Exp. 7 are PBE-VBN terpolymers having an

MFR as identified in Table 8. The polymers were made by the process described above and in US Patent Application No. 2005/0107534, using varying VNB content. Greater VNB content led to PBE polymers having a lower MFR.

TABLE 8

| | C2 | VNB | MFR | Density | % |
|---|---|---|---|---|---|
| Component | (wt %) | (wt %) | (g/10 min) | (g/cc) | Filler |
| VM 6102 | 16 | | 3 | 0.862 | |
| Exp. 5 | 20 | 0.16 | 1.2 | N/A | |
| Exp. 6 | 20 | 0.32 | 0.6 | N/A | |
| Exp. 7 | 19 | 0.47 | 0.3 | N/A | |
| PP 7032 | 9 | | 3 | 0.900 | |
| HifaxTM CA 10 A | 19 | | 0.5 | 0.880 | |
| Conc. 80 or HM 10 | | | | NA | 20% |
| (Fire Retardant | | | | | |
| Masterbatch) | | | | | |
| Conc. 27 UHP (UV | | | | NA | 73% |
| Stablizer Masterbatch) | | | | | |

Table 9 shows TPO formulations in grams. Examples C4, C5 and C6 are controls. Example C4 contains Hifax™ CA 10 A, while examples C5 and C6 contain Vistamaxx™ 6100 PBE. The formulations were compounded in the Intelli-torque Brabender using a melt temperature of 200° C. at a low RPM to flux and then mixed at 50 RPM for 3 minutes. The batch weight of each formulation was about 270 g.

TABLE 9

| | | | | Example 5 | Example 6 | Example 7 |
|---|---|---|---|---|---|---|
| | C4 | C5 | C6 | (E5) | (E6) | (E7) |
| Hifax CA10A | 153 | | | | | |
| VM 6100 | | 75 | 75 | | | |
| Exp. 5 | | | | 75 | | |
| Exp. 6 | | | | | 75 | |
| Exp. 7 | | | | | | 75 |
| PP 7032 | | 75 | | 75 | 75 | 75 |
| Braskem TI 4007 G | | | 75 | | | |
| Conc. 80 | 76 | 75 | 75 | 75 | 75 | 75 |
| Conc. 27 UHP | 44 | 43 | 43 | 43 | 43 | 43 |
| Total [g] | 273 | 269 | 269 | 269 | 269 | 269 |
| MFR | 1.09 | 3.7 | 2.0 | 2.4 | 1.9 | 1.5 |
| Tan delta Peak | −26.7 | −27.3 | −27.3 | −28.7 | −29.2 | −29.2 |
| Flex Modulus | 166 | 315 | 328 | 330 | 356 | 325 |
| Flex Mod. (std dev) | 25.4 | 22 | 45 | 23 | 20 | 26 |

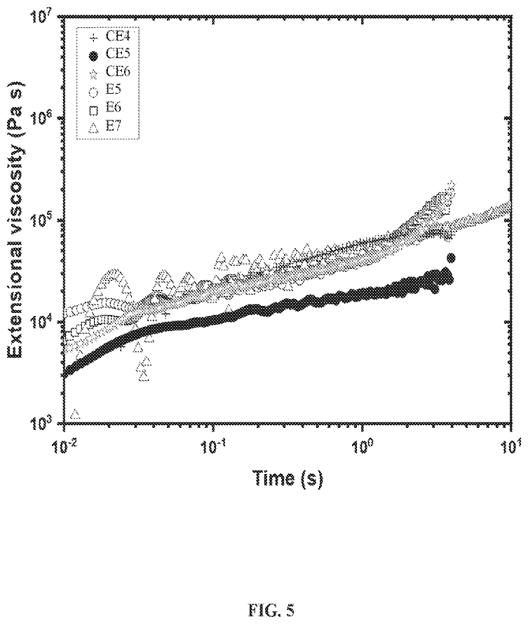

FIG. 5 is a graph illustrating extensional viscosity of the six compositions. The US-EV method described above was used. Compared to control examples C5 and C6, the inventive formulation of Examples 6 and 7 display much higher melt strength, very close to the performance of control example C4. This indicates the inventive formulations of Examples 6 and 7 provide the processability parameters for TPO roofing applications.

Table 10 provides extensional viscosity data for controls C4, C5, and C6 and inventive Examples E5, E6 and E7. At small corrected times, i.e. 0.001 seconds, the test method may have high levels of noise. At greater corrected times, where extensional viscosity measurements are more consistent and accurate, it can be seen that inventive Examples E6 and E7 perform comparably to control sample C4, and much greater than PBE control compositions C5 and C6.

TABLE 10

| Corrected time [s] | C4 | C5 | C6 | E5 | E6 | E7 |
|---|---|---|---|---|---|---|
| 0.001 | NA | 284.2 | 3281.7 | 10734.8 | 3189.4 | 282.2 |
| 0.01 | 3086.0 | 3383.3 | 5506.8 | 12149.6 | 7219.3 | 1212.8 |
| 0.1 | 24228.2 | 10435.9 | 20276.9 | 18945.1 | 18837.3 | 17703.3 |
| 1 | 58866.7 | 19290.0 | 41582.9 | 42656.2 | 50399.1 | 48322.3 |

Table 11 illustrates the percentage increase in extensional viscosity for inventive Examples E5, E6 and E7 as compared to control sample C5. Sample C5 includes a PBE having an MFR of 3 as compared to the inventive Examples E5, E6 and E7, which each includes a PBE having an MFR of less than 2. Achieving a PBE having a lower MFR corresponds to extensional viscosity improvements of roughly 80%450% or more across the test range. This further supports that the inventive PBE formulations of Examples E5, E6 and E7 provide the processability parameters for TPO roofing applications.

TABLE 11

| Corrected time [s] | E5 | E6 | E7 |
|---|---|---|---|
| 0.001 | 3677% | 1022% | −1% |
| 0.01 | 259% | 113% | −64% |
| 0.1 | 82% | 81% | 70% |
| 1 | 121% | 161% | 151% |

### IV. Branched Propylene-Based Elastomers

Exp. 8, Exp. 9, Exp. 10, and Exp. 11 are branched propylene-based elastomers having varying amounts of branching and varying Mw, made according to the process described above, per parameters described below. AOTEMPO is a radical trapping agent (4-Acryloyloxy-2,2,6,6-tetramethylpiperidine-N-oxyl), available from Sigma Aldrich. Luperox® 101 is a peroxide polymer initiator available from Arkema. TAIC is triallyl isocyanurate, a coagent, available from Evonik.

Branched PBEs Exp. 8, Exp. 9, Exp. 10, and Exp. 11 were prepared via a melt blending process. The branched PBE formulations are prepared in a brabender batch mixer of 70 cc capacity at 100 rpm and metal set temperature of 150° C. At time zero the VistamaxxTM 6100 is charged in to the mixer. After about 2-3 minutes of mixing, a radical trapping agent (AOTEMPO), a coagent (TAIC) and peroxide (Luperox® 101) are charged to the mixer. The mixing continued for another 4 minutes. For Exp. 8, peroxide was first added to the Vistamaxx™ 6100, and then the coagent was added second; no radical trapping agent was used. For Exp. 9, the radical trapping agent was added first, then the peroxide, and then the coagent. For Exp. 10, the radical trapping agent was added first, and then the peroxide and coagent were added at the same time. For Exp. 11, peroxide and coagent were added at the same time; no radical trapping agent was used.

TABLE 12

| | Exp. 8 | Exp. 9 | Exp. 10 | Exp. 11 |
|---|---|---|---|---|
| Vistamaxx 6100 | 98.6 | 98.6 | 98.6 | 98.6 |
| AOTEMPO | | 0.72 | 0.72 | |
| Luperox ® 101 | 0.95 | 0.95 | 0.95 | 0.95 |
| TAIC | 0.45 | 0.45 | 0.45 | 0.45 |
| Total | 100 | 100.72 | 100.72 | 100 |
| MFR at 2.16 kg/ | | | 4.2 | 67.2 |
| 230° C. | | | | |
| MFR at 21.6 kg/ | | | 168.9 | Too high |
| 230° C. | | | | |
| Zero shear viscosity, | | | 206820 | 16624 |
| Cross model fit | | | | |
| (Pa · s) | | | | |
| VGP Phase angle, @ | | | 37.1 | 37.5 |
| G* = 105 Pa (°) | | | | |
| Mn (g/mol) (LS) | | | 102757 | 49408 |
| Mw (g/mol) (LS) | | | 307276 | 300779 |
| Mz (g/mol) (LS) | | | 854428 | 2474890 |
| Mw/Mn (IR) | | | 2.93 | 4.36 |
| g′ (GPC) | | | 0.8 | 0.6 |

Table 13 shows the raw materials that includes both polymers and additives used in the roofing formulations.

TABLE 13

| | C2 | MFR | Density | % |
|---|---|---|---|---|
| Component | (wt %) | (g/10 min) | (g/cc) | Filler |
| VM6102 | 16 | 3 | 0.862 | |
| Exp. 8 | NA | NA | NA | |
| Exp. 9 | NA | NA | NA | |
| Exp. 10 | NA | 4.2 | NA | |
| Exp. 11 | NA | 67.2 | NA | |
| PP 7032 | 9 | 3 | 0.900 | |
| Conc. 80 (Fire Retardant | | | NA | 20% |
| Masterbatch) | | | | |
| Conc. 27 UHP | | | NA | 73% |
| (UV Stablizer Masterbatch) | | | | |

Table 14 shows TPO formulations, in weight percent. Examples C7 and C8 are a controls; Example C7 contains Vistamaxx™ 6102 PBE, while Example C8 includes Hifax™ CA 10 A. The formulations were compounded in two stages. First, the branching process was executed at 190° C., as described above, followed by addition of the remaining TPO components (i.e., PP 7032) to the mixer. Then, in a second mixing stage, the additives were added.

TABLE 14

| | | | Example 8 | Example 9 | Example 10 | Example 11 |
|---|---|---|---|---|---|---|
| | C7 | C8 | (E8) | (E9) | (E10) | (E11) |
| Vistamaxx 6102 | 28 | | | | | |
| Exp. 8 | | | 28 | | | |
| Exp. 9 | | | | 28 | | |
| Exp. 10 | | | | | 28 | |
| Exp. 11 | | | | | | 28 |
| PP 7032 | 28 | | 28 | 28 | 28 | 28 |
| HifaxTM CA 10 A | | 56 | | | | |
| Fire Retardant MB | 28 | 28 | 28 | 28 | 28 | 28 |
| UV Stabilizer MB | 16 | 16 | 16 | 16 | 16 | 16 |
| Total [wt %] | 100 | 100 | 100 | 100 | 100 | 100 |
| MFR | 3.1 | NA | 5.0 | 4.7 | 3.9 | 3.3 |
| Flex Modulus | 438 | NA | 372 | 396 | 417 | 386 |
| Young's Modulus, | 538 | NA | 329 | 494 | 479 | 506 |
| MPa | | | | | | |
| Tensile Strength | 6.6 | NA | 5.8 | 6.1 | 5.8 | 7.0 |
| @ Yield, MPa | | | | | | |
| Elongation at | 7 | NA | 8 | 6 | 5 | 10 |
| Yield, MPa | | | | | | |
| Elongation at | 425 | NA | 350 | 294 | 352 | 426 |
| Break, % | | | | | | |
| Tensile Strength at | 10.3 | NA | 8.0 | 7.7 | 8.4 | 11.8 |
| Break, MPa | | | | | | |

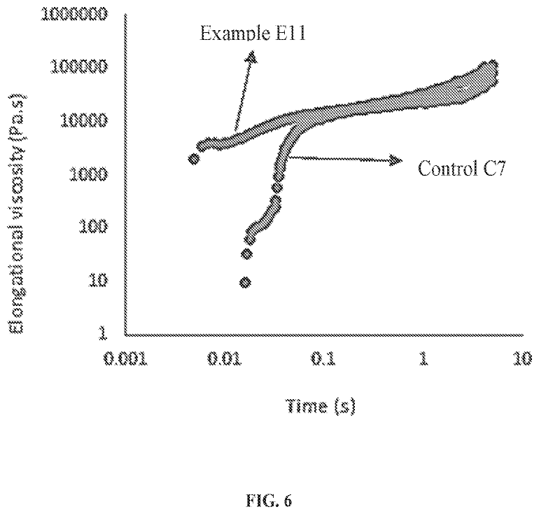

FIG. 6 is a graph illustrating extensional viscosity of control example C7 and inventive Example El 1. Compared to control example C7, the inventive formulation of Example E11 displays higher melt strength. This indicates the inventive formulation of Example E11, which includes long-chain branching, provides improved processability parameters for TPO roofing applications.

Table 15 provides extensional viscosity data for control C7 and inventive Example E11. Inventive Example E11 perform better than the PBE control compositions C7, which does not have long chain branching.

TABLE 15

| Corrected Time (s) | C7 | E11 |
|---|---|---|
| 0.1 | 12373.8 | 14796.2 |
| 1 | 23469.8 | 32635 |

Table 16 illustrates the percentage increase in extensional viscosity for inventive Example E11 as compared to control sample C7. Sample C7 includes a PBE that does not have long chain branching, as compared to the inventive Example E11, which each includes a PBE that does have long chain branching. Long chain branching corresponds to extensional viscosity improvements of roughly 20%-30% or more across the test range. This further supports that the addition of long-chain branching to propylene-based polymer provides the processability parameters for TPO roofing applications.

TABLE 16

| Corrected Time (s) | E11 |
|---|---|
| 0.1 | 19.6% |
| 1 | 39.1% |

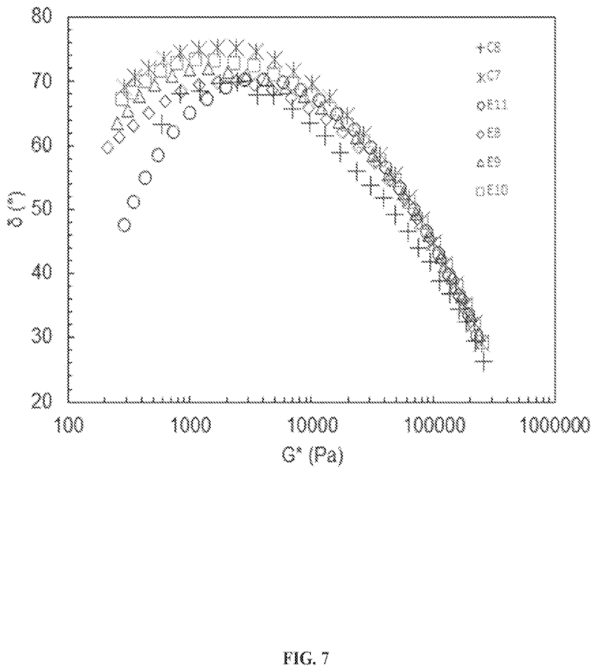

As known by one of skill in the art, rheological data may be presented by plotting the phase angle versus the absolute value of the complex shear modulus (G*) to produce a Van Gurp-Palmen plot of complex modulus (Pa) versus phase angle (deg). FIG. 7 is a Van Gurp-Palmen plot (VGP plot) including control samples C7 and C8 and inventive Examples E8, E9, E10 and E11. A Van Gurp-Palmen plot provides visualization of the elasticity of a polymer. Each of the inventive examples having long chain branching show improved elasticity over the PBE control, C7; that is, the phase angle per given modulus is less for the inventive examples than for the PBE control C7. Table 17 includes the phase angle values for each Example at moduli of 500 Pa and 1000 Pa. Examples E8 and E11 perform close to or better than the commercial control, C8; Examples E9 and E10 show improved elasticity over the PBE control C7. The improved elasticity shown by the inventive examples indicates that the addition of long-chain branching to propylene-based polymer provides the processability parameters for TPO roofing applications.

TABLE 17

| G* (Pa) | C7 | C8 | E8 | E9 | E10 | E11 |
|---|---|---|---|---|---|---|
| 500 | 72.5 | 63 | 65 | 69 | 72 | 59 |
| 1000 | 75 | 68.5 | 69.5 | 72 | 73 | 65 |

### V. PBE-g-PS

Samples were prepared according to Table 18, where a desired amount of DCP was dissolved in the styrene monomers, and then the VISTAMAXX™ particles were impregnated with the styrene solution with a mechanical stirring. The mixtures were put into an airtight container and were kept for 8 hours at room temperature for diffusion of monomers with the VISTAMAXX™ particles. All the melt blending, in-situ grafting, and in-situ polymerization processes of samples were carried out in a twin-screw extruder with a screw speed of 100 rpm. The extruder barrel temperatures were set on 200° C. from feed zone to die exit.

TABLE 18

| Sample | VISTAMAXX ™ | PP | Styrene | DCP |
|---|---|---|---|---|
| Number | Grade | (wt %) | (wt %) | (wt %) |
| PS-1 | 6102 | 100 | 0 | 0 |
| PS-2 | 6102 | 90 | 10 | 0.6 |
| PS-3 | 6102 | 80 | 20 | 1.2 |
| PS-4 | 6102 | 70 | 30 | 1.8 |
| PS-5 | 3588 | 80 | 20 | 1.2 |

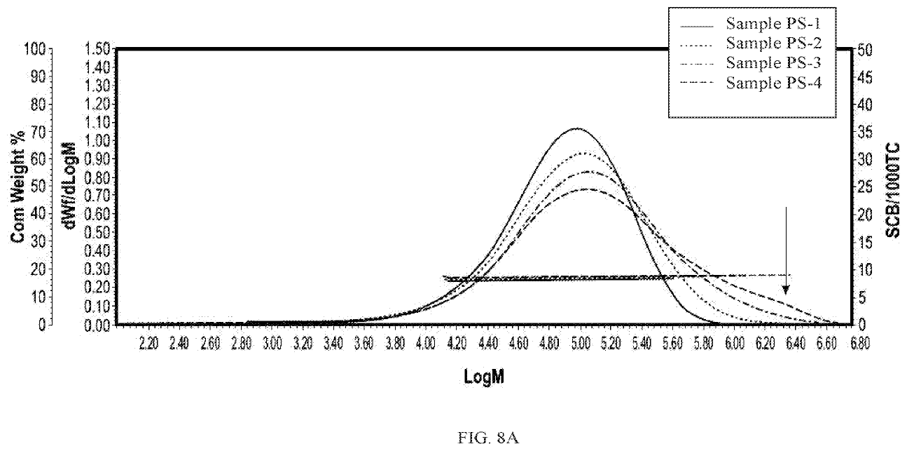

GPC was used to evaluate the molecular weight change. FIG. 8A illustrates the GPC data for the resultant polymers (FIG. 8B is a zoomed in plot of FIG. 8A). The Mw and viscosity increases with increasing amounts of styrene compared with neat VISTAMAXXTM. Table 19 provides details from the GPC data for some of the samples.

TABLE 19

| Sample | Mw | Mn | | Bulk | IV |
|---|---|---|---|---|---|
| Number | (g/mol) | (g/mol) | MWD | Comonomer | (dL/g) |
| PS-1 | 110,000 | 44,000 | 2.5 | 16 | 1.7 |
| PS-3 | 215,000 | 25,000 | 8.8 | 18 | 2.6 |
| PS-4 | 290,000 | 19,000 | 15.6 | 18 | 3.0 |

Blend compositions were prepared according to Table 20, where the MgOH₂ Masterbatch is 30 wt % MgOH₂ in ADFLEX™ KS 311P (a polypropylene impact copolymer, available from LyondellBasell); the UV Stabilizer Masterbatch comprises UV stabilizing additives, titanium-dioxide as the white pigment, and a carrier resin and has a density of about 1.0 g/cm³, and the White Concentrate Masterbatch is 50 wt % titanium dioxide in propylene homopolymer. The VISTAMAXX™ 3588-g-PS was prepared similarly to the previous samples.

Table 20 also includes properties of said blends. The Blend C11 is comparable to the composition used in roofing membranes on the market.

TABLE 20

| Component | C9 | C10 | E12 | C11 |
|---|---|---|---|---|
| VISTAMAXX ™ 6102 (wt %) | 30.0 | | | |
| VISTAMAXX ™ 6100 (wt %) | | 30.0 | | |
| VISTAMAXX ™ 3588-g-PS (wt %) | | | 30.0 | |
| (11.5 wt % PS) | | | | |
| PP7032 (wt %) | 30.0 | 30.0 | 30.0 | |
| CA10A * (wt %) | | | | 60.0 |
| MgOH₂ Masterbatch (wt %) | 30.0 | 30.0 | 30.0 | 30.0 |
| UV Stabilizer Masterbatch (wt %) | 3.0 | 3.0 | 3.0 | 3.0 |
| White Concentrate Masterbatch (wt %) | 7.0 | 7.0 | 7.0 | 7.0 |

Properties

| | | | | |
|---|---|---|---|---|
| PM2019378 (g/10 min) | 5.9 ± 0.8 | 5.6 ± 0.8 | 5.1 ± 0.1 | 0.93 ± 0.01 |
| (230° C., 2.16 kg) | | | | |
| tan delta peak (° C.) | −30 | −28 | −8 | −28 |
| E″ peak (° C.) | −32 | −30 | −13 | −32 |

The tan delta peak is lower for inventive Example E12 than the control examples, due to the VISTAMAXX™ grade selection. Without being limited by theory, it is believed that the much lower C2 content in VISTAMAXX™ 3588 than VISTAMAXX™ 6100 and 6102 is decreasing the tan delta peak.

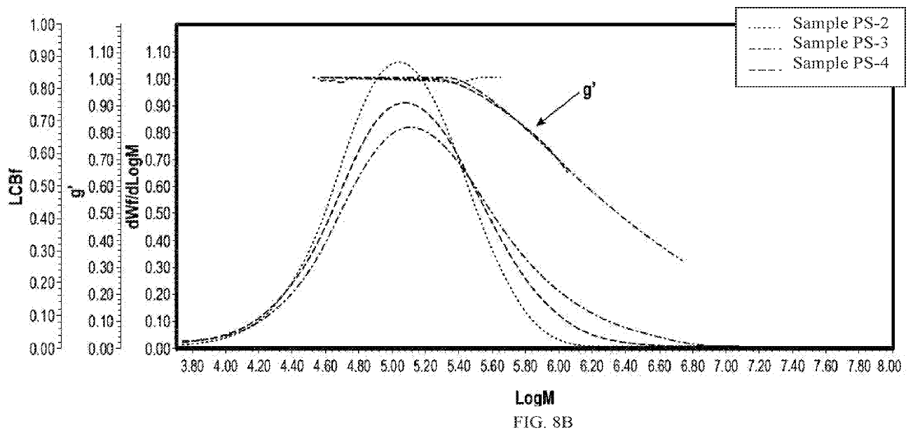

FIG. 9 shows a plot of Elastic modulus (E′) with temperature. The inventive Example E12 displays an equivalent modulus to control Blends C8, C10, and C11 at temperatures below -40° C. and similar modulus in the temperature range of −40° C. to 40° C., which is the typical temperature range for TPO roofing membrane application. Overall results show that properties of E12 are comparable with control samples.

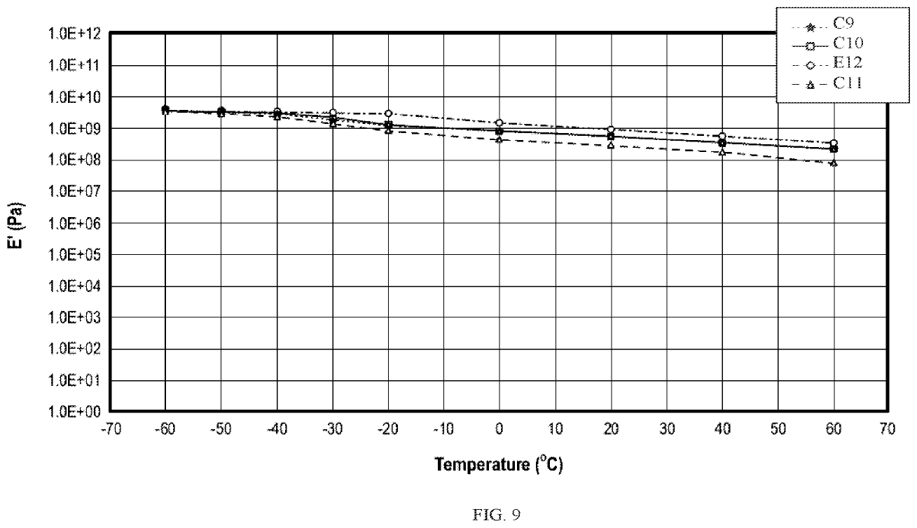

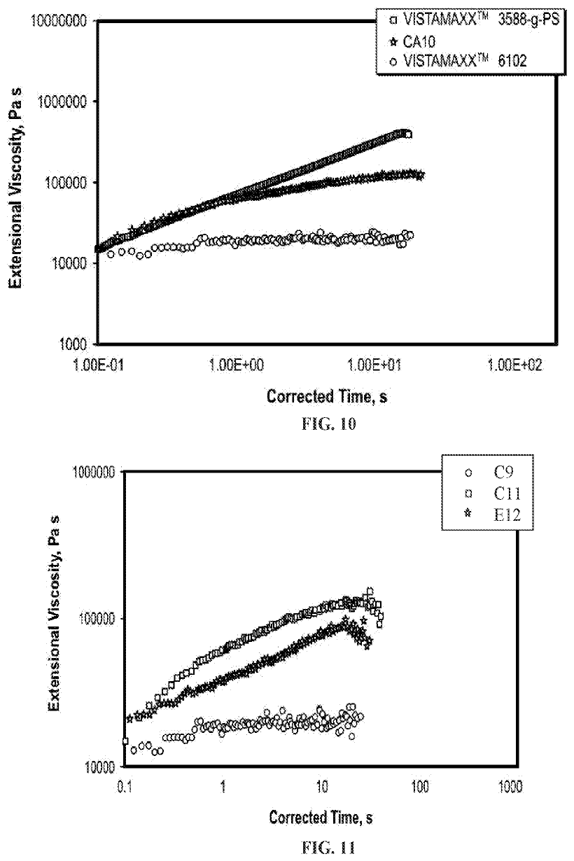

FIG. 10 shows the melt strength of selected neat polymers. FIG. 11 shows the melt strength of selected blends. The extensional viscosity test was conducted at 190° C. on ARES instrument with extensional viscosity fixture (EVF), Hencky rate is set at 0.1/s. A nitrogen atmosphere was used to avoid oxidative degradation. The melt strength of the VISTAMAXX™ 3588-g-PS is greater than the control neat polymers VISTAMAXX™ 6102 and CA10. Further, in the blends, the Example E12 is comparable in melt strength to the Blend C11, which approximates commercial blends.

Compared to control Blend C9, the Example E12 displays much higher melt strength, which is equivalent to Blend C11. This indicates the Example E12 fulfills the processability requirements for TPO roofing application.

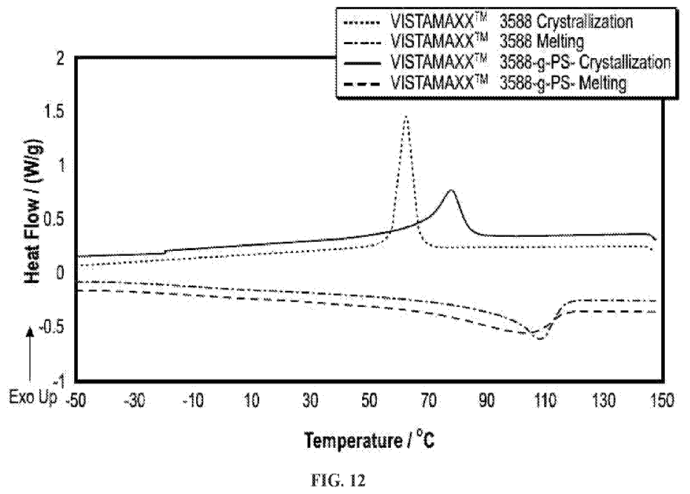

FIG. 12 shows the DSC results to compare the thermal behavior of the neat VISTAMAXX™ 3588 and the VISTAMAXX™ 3588-g-PS. The higher crystallization temperature means the improvement in cycle time (or production time because the product solidifies more quickly).

Higher melt strength makes the PP-g-PS described herein suitable for roofing applications. Further, the higher crystallization temperature of the PP-g-PS described herein reduces the cooling time, so the production time for roofing materials is reduced. Without being limited by theory, it is believed that the polystyrene grafts on the polypropylene backbone mimic long chain branching in other polypropylenes where long chain branching in such polymers increases the melt strength and increases the crystallization temperature of said polypropylenes.

Overall, compositions and membranes of the present disclosure can provide an improved balance of elastic modulus (flexibility) at temperatures from −40° C. to 40° C., elastic modulus at elevated temperatures (e.g., 100° C.) (an attribute that mitigates roll blocking), and higher melt strength (that provides improved dimensional stability in a sheeting process). The improved melt strength and processability provided by compositions of the present disclosure can provide uniform dispersion of fillers, if present in a composition, which provides more uniform layers (films) for roofing applications, providing improved physical properties of the layers (films).

Certain embodiments and features have been described using a set of numerical upper limits and a set of numerical lower limits. It should be appreciated that ranges from any lower limit to any upper limit are contemplated unless otherwise indicated. All numerical values are “about” or “approximately” the indicated value, and take into account experimental error and variations that would be expected by a person having ordinary skill in the art.

To the extent a term used in a claim is not defined above, it should be given the broadest definition persons in the pertinent art have given that term as reflected in at least one printed publication or issued patent.

While the present disclosure has been described with respect to a number of embodiments and examples, those skilled in the art, having benefit of this disclosure, will appreciate that other embodiments can be devised which do not depart from the scope and spirit of the present disclosure.

What is claimed is:

1. A roofing composition, comprising:
a polymer blend, comprising:
a propylene-based elastomer, wherein the propylene-based elastomer has a melt flow rate of less than about 3 g/10 min, according to ASTM D-1238 (2.16 kg weight @ 230° C.); and
a thermoplastic resin;
a UV stabilizer; and
a fire retardant.

2. The roofing composition of claim 1, wherein the propylene-based elastomer has:
an Mw of about 300,000 g/mol to about 600,000 g/mol.

3. The roofing composition of claim 1, wherein the propylene-based elastomer has at least one of the following properties:
an Mw of from about 500,000 g/mol to about 600,000 g/mol,
a melt flow rate of from about 0.1 dg/min to about 2 dg/min, according to ASTM 1238 (2.16 kg @ 230° C.),
a percent crystallinity that less than about 3,
a density of from about 0.85 g/cm³ to about 0.87 g/cm³, according to ASTM D-1505,
a melt index of from about 0.5 g/10 min to about 3.0 g/10 min, according to ASTM D-1238 (2.16 kg@230° C.), and
a number average molecular weight (Mn) of from about 150,000 g/mol to about 350,000 g/mol.

4.-5. (canceled)

6. The roofing composition of claim 1, wherein the polymer blend comprises from 8 to 15 wt % ethylene, based on the total weight of the polymer blend.

7. A roofing composition, comprising:
a polymer blend, comprising:
a propylene-based elastomer, wherein the propylene-based elastomer has a branching index, g′, less than 1, according to GPC-4D; and
a thermoplastic resin;
a UV stabilizer; and
a fire retardant.

8. The roofing composition of claim 7, wherein the propylene-based polymer comprises:
at least 60 wt % propylene-derived units;
from 0.3 to 10 wt % diene-derived units; and
at least 6 wt % ethylene-derived units,
wherein the wt % of each is based on the total weight of the propylene-based elastomer, and
wherein the propylene-based elastomer has isotactic polypropylene crystallinity, a melting point by DSC equal to or less than 110° C., and a heat of fusion of from 5 J/g to 50 J/g.

9. The roofing composition of claim 8, wherein the diene is 5-vinyl-2-norbornene (VNB).

10. The roofing composition of claim 7, wherein the propylene-based elastomer is partially insoluble and the fractions soluble at 23° C. and 31° C., as measured by the extraction method described herein, have ethylene contents differing by 5 wt % or less.

11.-19. (canceled)

20. A roofing composition, comprising:
a propylene-based elastomer-graft-polystyrene (PBE-g-PS) at about 20 wt % to about 50 wt % by weight of the TPO membrane;
a thermoplastic resin at about 5 wt % to about 50 wt % by weight of the roofing composition;
a UV stabilizer; and
a fire retardant.

21. The roofing composition of claim 20, wherein the propylene-based elastomer of the PBE-g-PS has 70 wt % to 95 wt % of propylene-derived units and 5 wt % to 30 wt % of C2 or C4-C6 a-olefin-derived units.

22. The roofing composition of claim 20, wherein the PBE-g-PS has at least one of the following properties:
a styrene content of about 1 wt % to about 40 wt %,
a melt flow rate of about 1 g/10 min to about 20 g/10 min according to ASTM D1238 (2.16 kg @230° C.),
a weight average molecular weight of about 100,000 g/mol to about 500,000 g/mol,
a number average molecular weight of about 5,000 g/mol to about 50,000 g/mol, and
a molecular weight distribution of about 3 to about 20.

23. The roofing composition of claim 1, wherein the roofing composition includes about 5 wt % to about 50 wt % of the thermoplastic resin, based on the total weight of the roofing membrane.

24. The roofing composition of claim 1 wherein the thermoplastic resin is selected from the group consisting of a polypropylene and an impact copolymer.

25-33. (canceled)

34. A roofing composition, comprising:
from 30 to 70 wt % of a polymer blend, the polymer blend comprising:
a propylene-based elastomer; and
a thermoplastic polyolefin;
a UV stabilizer; and
a fire retardant.

35. The roofing composition of claim 34, wherein the roofing composition has a phase angle at a complex modulus G* of 1,000 Pa of about 73 or less.

36.-37. (canceled)

38. The roofing composition of claim 34, wherein the roofing composition has an extensional viscosity at Henchy rate of is⁻¹ at 0.1 sec that is greater than 15,000 Pa-sec.

39.-40. (canceled)

41. The roofing composition of claim 34, wherein the polymer blend comprises from 30 to 70 wt % of the first polyolefin, based on the total weight of the polymer blend.

42. The roofing composition of claim 34, wherein the polymer blend comprises from 30 to 70 wt % of the second polyolefin, based on the total weight of the polymer blend

43. The roofing composition of claim 34, wherein the first polyolefin is a propylene-based elastomer.

44. The roofing composition of claim 34, wherein the second polyolefin is an impact copolymer comprising a polypropylene matrix phase and an ethylene-propylene rubber dispersed phase.

45. A roofing material, comprising:
a membrane comprising the roofing composition of claim 1; and
a base material adhered to or affixed to the membrane.

46.-47. (canceled)

48. A method comprising:
blending a composition comprising:
a propylene-based elastomer, wherein the propylene-based elastomer has a melt flow rate of less than about 3 g/10 min, according to ASTM D-1238 (2.16 kg weight @ 230° C.);
a thermoplastic resin;
a UV stabilizer; and
a fire retardant.
